(19) United States
(12) Patent Application Publication
(10) Pub. No.: US 2025/0056135 A1
(43) Pub. Date: Feb. 13, 2025

(54) IMAGE SIGNAL PROCESSOR AND IMAGE SIGNAL PROCESSING METHOD

(71) Applicant: SK hynix Inc., Icheon-si Gyeonggi-do (KR)

(72) Inventors: Cheol Jon JANG, Icheon-si Gyeonggi-do (KR); Dong Ik KIM, Icheon-si Gyeonggi-do (KR); Jun Hyeok CHOI, Icheon-si Gyeonggi-do (KR)

(73) Assignee: SK hynix Inc., Icheon-si Gyeonggi-do (KR)

(21) Appl. No.: 18/539,084

(22) Filed: Dec. 13, 2023

(30) Foreign Application Priority Data
Aug. 10, 2023 (KR) 10-2023-0104681

(51) Int. Cl. H04N 25/68; G06T 3/4015; G06T 7/13

(52) U.S. Cl. CPC H04N 25/68; G06T 3/4015; G06T 7/13; G06T 2207/20164

(57) ABSTRACT

An image signal processor capable of processing image signals and an image signal processing method for the same are disclosed. The image signal processor includes a first determiner configured to determine whether a target kernel including a target pixel corresponds to a corner pattern, a second determiner configured to determine a corner pattern group corresponding to the target kernel when the target kernel corresponds to the corner pattern, a third determiner configured to determine a target corner pattern corresponding to the target kernel from among a plurality of corner patterns of a corner pattern group corresponding to the target kernel, and a pixel interpolator configured to interpolate the target pixel using pixel data of a pixel corresponding to the target corner pattern.

### CROSS-REFERENCE TO RELATED APPLICATION

This patent document claims the priority under 35 U.S.C. § 119 to, and benefits of, Korean patent application No. 10-2023-0104681, filed on Aug. 10, 2023, which is hereby incorporated by reference in its entirety as part of the disclosure of this patent document.

### TECHNICAL FIELD

The technology and implementations disclosed in this patent document generally relate to an image signal processor capable of processing image signals and an image signal processing method for the same.

### BACKGROUND

An image sensing device is a device for capturing optical images by converting light into electrical signals using a photosensitive semiconductor material which reacts to light. With the development of automotive, medical, computer and communication industries, the demand for high-performance image sensing devices has been increasing in various fields, such as smart phones, digital cameras, game machines, IoT (Internet of Things), robots, surveillance cameras and medical micro cameras.

An original image captured by the image sensing device may include a plurality of pixels corresponding to different colors (e.g., red, blue, and green). The plurality of pixels included in the original image may be arranged according to a certain color pattern (e.g., Bayer pattern). In order to convert the original image into a complete image (e.g., RGB images), an operation of interpolating pixels may be performed according to a predetermined algorithm. Since this algorithm basically includes an operation of interpolating pixels having lost (or missed) information using information of the neighboring pixels, serious noise in images with specific patterns may occur due to limitations of such algorithm.

### SUMMARY

In accordance with an embodiment of the disclosed technology, an image signal processor may include a first determiner configured to determine whether a target kernel including a target pixel corresponds to a corner pattern; a second determiner configured to determine a corner pattern group corresponding to the target kernel when the target kernel corresponds to the corner pattern; a third determiner configured to determine a target corner pattern corresponding to the target kernel from among a plurality of corner patterns of a corner pattern group corresponding to the target kernel; and a pixel interpolator configured to interpolate the target pixel using pixel data of a pixel corresponding to the target corner pattern.

In accordance with another embodiment of the disclosed technology, an image signal processing method may include distinguishing a plurality of corner patterns having different types from each other by using horizontal and vertical lines crossing a target kernel including a target pixel as a boundary; classifying the plurality of corner patterns into corner patterns of a first group and corner patterns of a second group; determining a target corner pattern from among corner patterns corresponding to any one of the first-group corner pattern and the second-group corner pattern; and interpolating the target pixel using pixel data of a pixel corresponding to the target corner pattern.

### BRIEF DESCRIPTION OF THE DRAWINGS

The above and other features and beneficial aspects of the disclosed technology will become readily apparent with reference to the following detailed description when considered in conjunction with the accompanying drawings.

FIG. 1 is a block diagram illustrating an example of an image signal processor based on some implementations of the disclosed technology.

FIG. 2 is a block diagram illustrating an example of a defective pixel corrector shown in FIG. 1 based on some implementations of the disclosed technology.

FIG. 3 is a flowchart illustrating an example operation of the defective pixel corrector shown in FIG. 2 based on some implementations of the disclosed technology.

FIG. 4 is a schematic diagram illustrating an example of a corner pattern based on some implementations of the disclosed technology.

FIG. 5 is a schematic diagram illustrating an example operation of determining a boundary of the corner pattern by the defective pixel corrector of FIG. 2 based on some implementations of the disclosed technology.

FIG. 6 is a schematic diagram illustrating an example of a target kernel arranged in a Bayer pattern based on some implementations of the disclosed technology.

FIG. 7 is a schematic diagram illustrating an example of a method for calculating a gradient sum by a first determiner shown in FIG. 2 based on some implementations of the disclosed technology.

FIG. 8 is a schematic diagram illustrating an example of the position of a target pixel in a corner pattern based on some implementations of the disclosed technology.

FIG. 9 is a schematic diagram illustrating an example of a method for determining whether the gradient directions cross each other by a second determiner of FIG. 2 based on some implementations of the disclosed technology.

FIG. 10 is a schematic diagram illustrating an example of a method for determining whether the gradient directions are identical to each other by a second determiner of FIG. 2 based on some implementations of the disclosed technology.

FIG. 11 is a schematic diagram illustrating an example of a method for determining whether there exist the same gradient directions by a third determiner of FIG. 2 based on some implementations of the disclosed technology.

FIGS. 12 to 15 are schematic diagrams illustrating examples of a method for compensating for a corner pattern by a pixel interpolator shown in FIG. 2 based on some implementations of the disclosed technology.

FIG. 16 is a block diagram illustrating an example of a computing device corresponding to the image signal processor of FIG. 1 based on some implementations of the disclosed technology.

### DETAILED DESCRIPTION

This patent document provides implementations and examples of an image signal processor and an image signal processing method for processing image signals that may be used in configurations to substantially address one or more technical or engineering issues and to mitigate limitations or disadvantages encountered in some image signal processors in the art. Some implementations of the disclosed technology relate to an image signal processor and an image signal processing method that can increase the accuracy of correction of a target pixel. In recognition of the issues above, the image signal processor based on some implementations of the disclosed technology can increase the accuracy of correction of the target pixel even when a target kernel corresponds to a corner pattern.

Reference will now be made in detail to some embodiments of the disclosed technology, examples of which are illustrated in the accompanying drawings. Wherever possible, the same reference numbers will be used throughout the drawings to refer to the same or like parts. While the disclosure is susceptible to various modifications and alternative forms, specific embodiments thereof are shown by way of example in the drawings. However, the disclosure should not be construed as being limited to the embodiments set forth herein.

Hereinafter, various embodiments will be described with reference to the accompanying drawings. However, it should be understood that the disclosed technology is not limited to specific embodiments, but includes various modifications, equivalents and/or alternatives of the embodiments. The embodiments of the disclosed technology may provide a variety of effects capable of being directly or indirectly recognized through the disclosed technology.

Various embodiments of the disclosed technology relate to an image signal processor capable of increasing the accuracy of correction of a target pixel, and an image signal processing method for the same.

It is to be understood that both the foregoing general description and the following detailed description of the disclosed technology are illustrative and explanatory and are intended to provide further explanation of the disclosure as claimed.

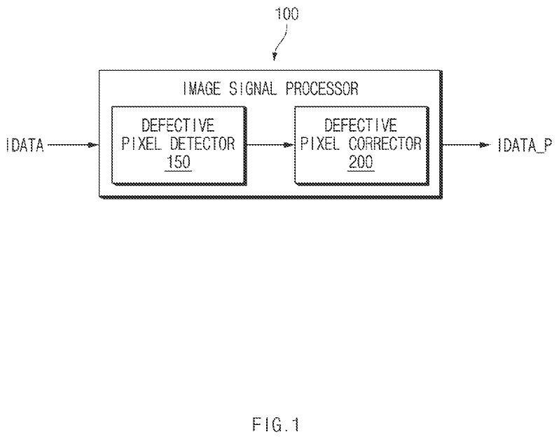

FIG. 1 is a block diagram illustrating an example of an image signal processor 100 based on some implementations of the disclosed technology.

Referring to FIG. 1, the image signal processor (ISP) 100 may perform at least one image signal process on image data (IDATA) to generate the processed image data (IDATA_P). The image signal processor 100 may reduce noise of the image data (IDATA) and may perform various kinds of image signal processing (e.g., demosaicing, defect pixel correction, gamma correction, color filter array interpolation, color matrix, color correction, color enhancement, lens distortion correction, etc.) for improving the image-quality of the image data.

In addition, the image signal processor 100 may compress the image data that has been created by performing image signal processing, which improves the image-quality, such that the image signal processor 100 can create an image file using the compressed image data. Alternatively, the image signal processor 100 may recover image data from the image file. In this case, the scheme for compressing such image data may be a reversible format or an irreversible format. As a representative example of such compression format, in the case of using a still image, Joint Photographic Experts Group (JPEG) format, JPEG 2000 format, or the like can be used. In addition, in the case of using moving images, a plurality of frames can be compressed according to Moving Picture Experts Group (MPEG) standards such that moving image files can be created.

The image data (IDATA) may be generated by an image sensing device that captures an optical image of a scene, but the scope of the disclosed technology is not limited thereto. The image sensing device may include a pixel array including a plurality of pixels configured to sense incident light received from a scene, a control circuit configured to control the pixel array, and a readout circuit configured to output digital image data (IDATA) by converting an analog pixel signal received from the pixel array into the digital image data (IDATA). In some implementations of the disclosed technology, it is assumed that the image data (IDATA) is generated by the image sensing device.

The pixel array of the image sensing device may include defective pixels that cannot normally capture a color image due to process limitations or temporary noise inflow. In addition, the pixel array may include phase difference detection pixels configured to acquire phase-difference-related information to implement the autofocus function. The phase difference detection pixels cannot acquire color images in the same manner as defective pixels such that the phase difference detection pixels can be treated as defective pixels from the point of view of color images. In some implementations, for convenience of description and better understanding of the disclosed technology, the defective pixel and the phase difference detection pixel, each of which cannot normally acquire a color image, will hereinafter be collectively referred to as “defective pixels”.

In order to increase the quality of color images, it is essential to improve the accuracy of correcting defective pixels. To this end, the image signal processor 100, based on some implementations of the disclosed technology, may include a defective pixel detector 150 and a defective pixel corrector 200.

The defective pixel detector 150 may detect pixel data of the defective pixel from the image data (IDATA). In some implementations of the disclosed technology, for convenience of description, digital data corresponding to a pixel signal of each pixel will hereinafter be defined as pixel data, and a set of pixel data corresponding to a predetermined unit (e.g., a frame or kernel) will hereinafter be defined as image data (IDATA). Here, the frame may correspond to the entire pixel array including the plurality of pixels. The kernel may refer to a unit for image signal processing. For example, the kernel may refer to a group of the pixels on which the image signal processing is performed at one time. In addition, an actual value of the pixel data may be defined as a “pixel value”.

In some implementations, the defective pixel detector 150 may detect pixel data of the defective pixel based on the image data (IDATA). For example, the defective pixel detector 150 may compare pixel data of a target pixel with an average value of pixel data of the pixels in the kernel (hereinafter, the average value of the pixel data of the kernel). The defective pixel detector 150 may determine whether the target pixel is a defective pixel based on a difference between the pixel data of the target pixel and the average value of the pixel data of the kernel. For example, the defective pixel detector 150 may determine that the target pixel is a defective pixel when the difference is equal to or greater than a threshold value.

In some other implementations, the defective pixel detector 150 may receive pre-stored position information of defective pixels obtained based on a previous process for correcting the defective pixel or a pixel test process. Further, the defective pixel detector 150 may determine whether the target pixel is a defective pixel based on the position information of the defective pixels. For example, the image sensing device may determine position information of inherently defective pixels as the position information of the defective pixels. Here, the inherently defective Further, the image sensing device may store the position information of the defective pixels in an internal storage (e.g., one-time programmable (OTP) memory) and may provide the position information of the defective pixels to the image signal processor 100.

When the target pixel is determined to be a defective pixel by the defective pixel detector 150, the defective pixel corrector 200 may correct pixel data of the target pixel based on image data of a kernel including the target pixel.

Since the embodiments of the disclosed technology can be applied to the case in which the target pixel is a defective pixel, it is assumed that the target pixel corresponds to a defective pixel, and the expression “defective pixel” will hereinafter be referred to as a “target pixel” for convenience of description. In addition, a kernel including a target pixel will hereinafter be referred to as a “target kernel”. Although the target pixel is generally located at the center of the target kernel and serves as a center pixel, in some cases, the target pixel may also be included in other areas of the target kernel apart from the center of the target kernel.

In addition, a (5×5)-sized kernel having 25 pixels arranged in a (5×5) array and arranged in a Bayer pattern will hereinafter be described as an example. The Bayer pattern may be a color arrangement pattern of a color filter array (CFA) arranged similarly to human eyes. The human eyes can distinguish green better than red and blue. In order to reflect characteristics of human eyes, ¼ of pixels included in one image sensor in the Bayer pattern may sense red components, the other ¼ of the pixels included in one image sensor in the Bayer pattern may sense blue components, and ½ of the pixels included in one image sensor in the Bayer pattern may measure green components. The embodiment of the disclosed technology disclosing that the image is a (5×5)-sized kernel is merely for convenience of description, and the technical idea of the disclosed technology can also be applied to another kernel in which color pixels are arranged in other patterns, such as a quad-Bayer pattern, a nona-Bayer pattern, a hexa-Bayer pattern, an RGBW pattern, a mono pattern, etc., and the types of image patterns are not limited thereto and can also be sufficiently changed as needed. In addition, a kernel having another size (e.g., a (10×10) size) other than the (5×5) size may be used depending on the performance of the image signal processor 100, required correction accuracy, an arrangement method of color pixels, and the like.

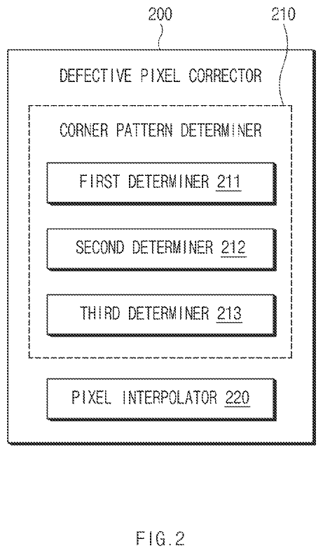

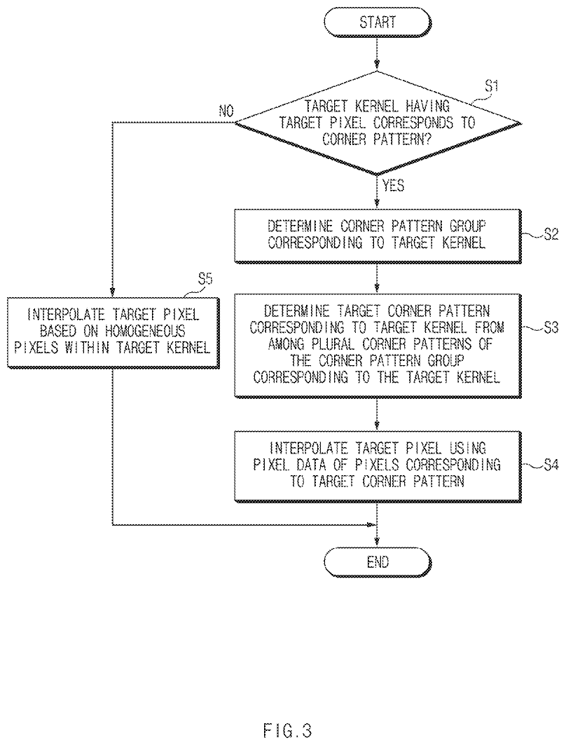

FIG. 2 is a block diagram illustrating an example of the defective pixel corrector, shown in FIG. 1, based on some implementations of the disclosed technology. FIG. 3 is a flowchart illustrating an example operation of the defective pixel corrector, shown in FIG. 2, based on some implementations of the disclosed technology.

Referring to FIG. 2, the defective pixel corrector 200 may include a corner pattern determiner 210 and a pixel interpolator 220.

The defective pixel corrector 200 may determine whether predetermined conditions are satisfied in a target kernel including a target pixel, determine a type of the target kernel, and interpolate the target pixel using an interpolation method corresponding to the determined type of the target kernel.

Here, the corner pattern determiner 210 may determine a corner pattern corresponding to the target kernel including the target pixel. The corner pattern determiner 210 may include a first determiner 211, a second determiner 212, and a third determiner 213.

Referring to FIGS. 2 and 3, the first determiner 211 may determine whether the target kernel including the target pixel corresponds to a corner pattern (Operation S1). The first determiner 211 may determine whether the target kernel corresponds to a corner pattern by calculating the directionality strength of the target kernel including the target pixel.

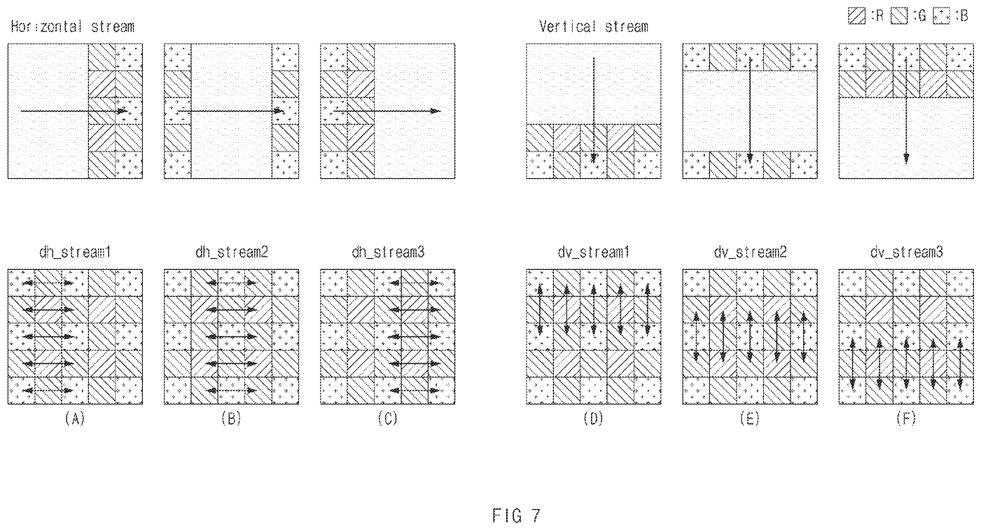

In some implementations, the directionality strength may be determined by calculating a gradient sum of a specific direction. Here, the gradient sum may be a value obtained by summing differences between pixel data values of pixels for each pixel pair arranged in the specific direction. An example of calculating the gradient sum will be described later in more detail with reference to FIG. 7.

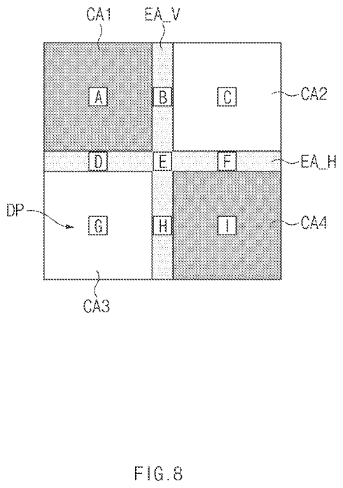

In addition, the first determiner 211 may calculate the gradient sum to determine which one of the regions from among the corner pattern includes a target pixel. For example, the first determiner 211 may determine the position of the target pixel based on the highest value from among gradient sums of a first direction (e.g., a horizontal direction) and the highest value from among gradient sums of a second direction (e.g., a vertical direction). An example of determining the position of the target pixel will be described in more detail with reference to FIG. 8 to be described later.

When the target kernel corresponds to a corner pattern, the second determiner 212 may determine a corner pattern group corresponding to the target kernel (Operation S2). For example, the second determiner 212 may determine whether the gradient directions cross each other in the target kernel and may determine whether the type of the corner pattern is the corner pattern of a first group or the corner pattern of a second group. Here, the gradient direction may be a directionality of a gradient based on a difference between pixel data values of pixels for each pixel pair within the target kernel. Crossing the gradient directions may mean that the gradient direction of pixels of a pixel pair arranged in the vertical (or horizontal) direction is different from the gradient direction of pixels of another pixel pair arranged in the vertical (or horizontal) direction.

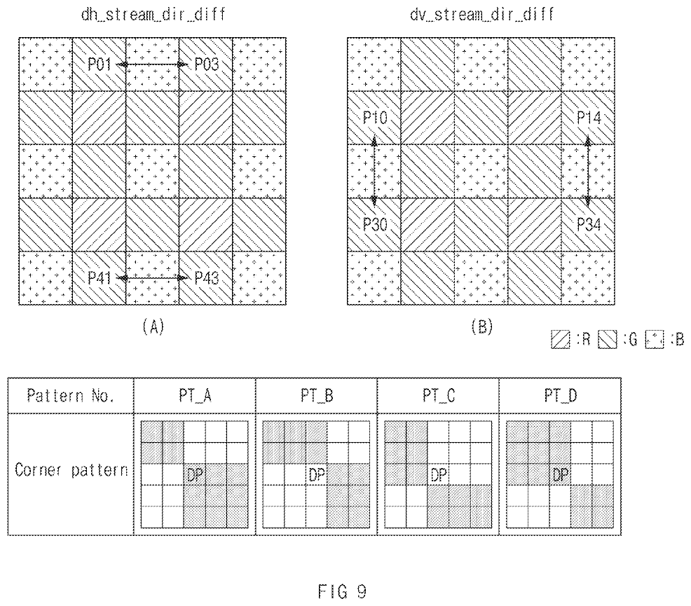

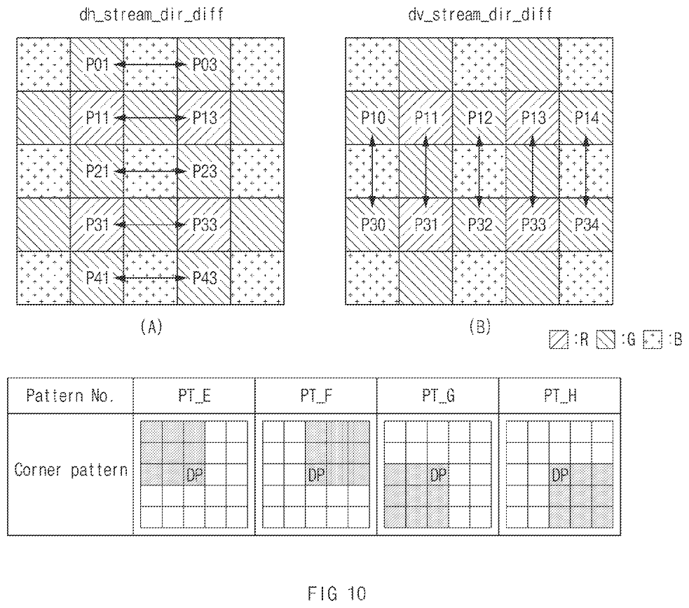

The second determiner 212 may determine whether the gradient directions of pixel pairs located to face each other in an edge region (i.e., an outer portion) of the target kernel cross each other. When the gradient directions cross each other (Operation S2), the second determiner 212 may determine that the corner pattern corresponds to the corner patterns of the first group. On the other hand, when the gradient directions are equal to each other (Operation S2), the second determiner 212 may determine that the corner pattern corresponds to the corner patterns of the second group. An example of determining the gradient direction will be described in more detail with reference to FIGS. 9 and 10 to be described later.

The third determiner 213 may determine a target corner pattern corresponding to the target kernel from among a plurality of corner patterns of the corner pattern group corresponding to the target kernel (Operation S3). The third determiner 213 may determine any one corner pattern (i.e., a target corner pattern) selected from among the corner patterns of the first or second group determined by the second determiner (212).

That is, when the second determiner 212 determines the corner pattern to be the corner pattern of the first group, the third determiner 213 may determine the target corner pattern from among the corner patterns of the first group. On the other hand, when the second determiner 212 determines the corner pattern to be the corner pattern of the second group, the third determiner 213 may determine the target corner pattern from among the corner patterns of the second group.

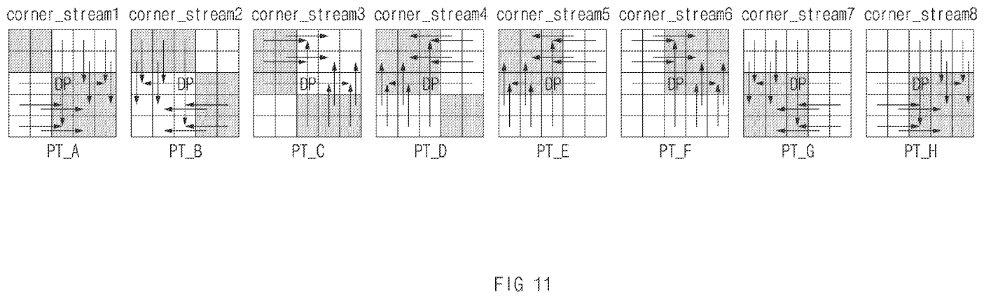

For example, the third determiner 213 may compare the gradient directions of a plurality of corner patterns with each other and may determine whether there is a pattern having the same gradient direction in the corner direction from among the plurality of corner patterns. An example of determining whether there is a pattern having the same gradient direction will be described in more detail with reference to FIG. 11 to be described later.

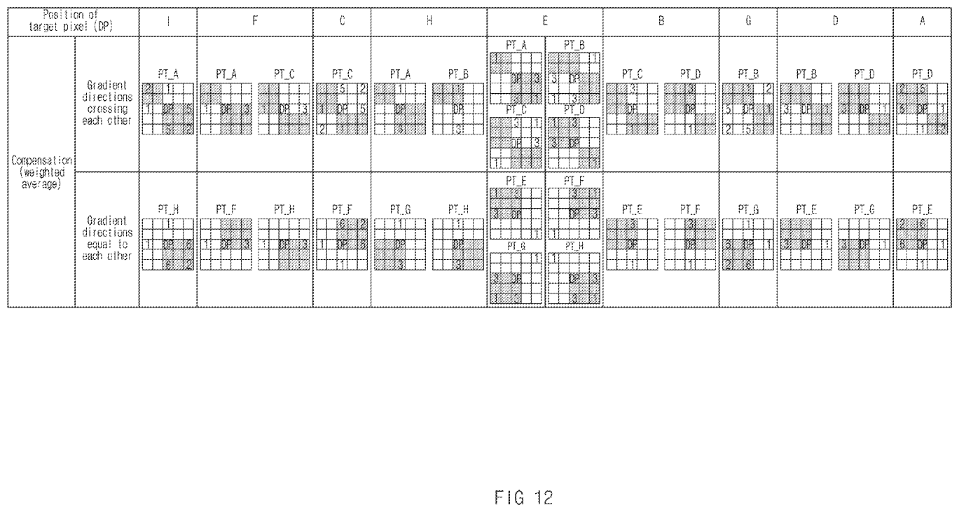

When the target corner pattern is determined by the corner pattern determiner 210, the pixel interpolator 220 may interpolate the target pixel using pixel data of the determined pixels (Operation S4). For example, the pixel interpolator 220 may determine an average (i.e., a weighted average) of weights of pixel data of peripheral pixels based on a corner pattern determined by the first determiner 211, the second determiner 212, and the third determiner 213 and may interpolate the target pixel based on the weighted average. An example of interpolating the target pixel will be described in more detail with reference to FIGS. 12 to 15 to be described later.

When the first determiner 211 determines that the target kernel including the target pixel does not correspond to the corner pattern (Operation S1), the pixel interpolator 220 may interpolate the target pixel based on pixel data of pixels (i.e., homogeneous pixels) having the same color as the target pixel within the target kernel (Operation S5). The embodiment of the disclosed technology disclosing the example case in which the target pixel in a target kernel not corresponding to the corner pattern is interpolated based on the homogeneous pixels is merely for convenience of description, and other implementations are possible, and it should be noted that the target pixel can also be interpolated in a variety of other ways as needed.

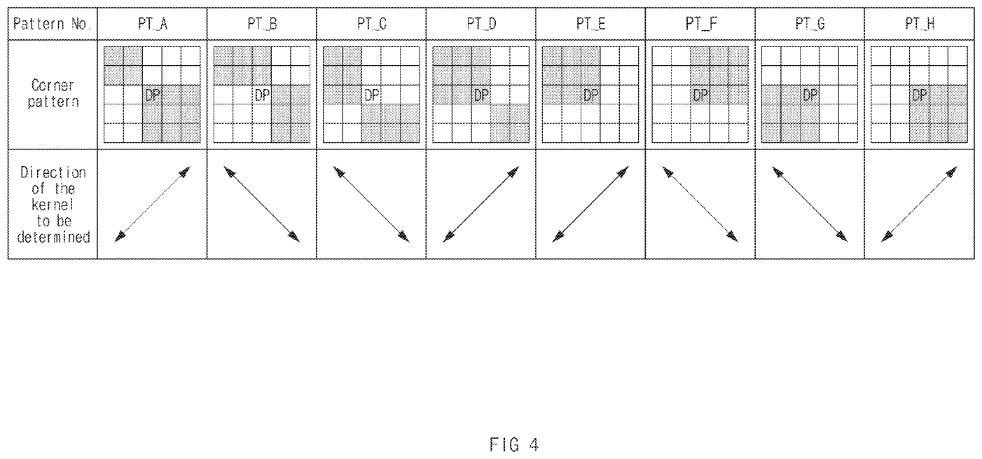

FIG. 4 is a schematic diagram illustrating an example of the corner pattern based on some implementations of the disclosed technology.

Referring to FIG. 4, image data IDATA (see FIG. 1) corresponding to one frame may include textures of various sizes and shapes. In FIG. 4, the shaped portions may refer to texture regions. The texture may refer to a set (or aggregate) of pixels having a similarity. For example, a subject having a unified color included in a captured scene may be recognized as a texture. The boundary of the texture may include a corner, and pixel data may vary greatly inside of the corner or outside of the corner.

Typically, when a portion of the corner is included in a kernel, the corner may refer to two sides that are located on the horizontal and vertical lines crossing the kernel and come in contact with each other at a point where the two lines cross each other. As such, a pattern in which pixels included in the kernel are distinguished from each other based on the corner serving as the boundary may be defined as a corner pattern. In this case, when the target pixel of the kernel is a defective pixel, the image signal processor 100 may correct a target pixel (DP) based on pixel data of adjacent pixels arranged to be distinguished from each other according to the corner pattern.

In the embodiment of the disclosed technology, it is assumed that a defective pixel correction operation is performed in units of a (5×5) kernel having 5 rows and 5 columns.

In FIG. 4, the first to twenty-fifth pixels may constitute the (5×5) kernel, and a pixel located at the center of the (5×5) kernel may correspond to the target pixel (TP). In addition, the shaded portion of FIG. 4 may refer to a texture region. Here, the pixel data of the target pixel (DP) may mean normal color pixel data that can be obtained when the target pixel (DP) is not a defective pixel.

Referring to FIG. 4, examples of corner patterns, each of which includes two corners, are illustrated as denoted by PT_A, PT_B, PT_C, and PT_D, respectively. In each of PT_A to PT_D of FIG. 4, various types of corner patterns, each of which includes two corners that come in contact with each other at one vertex of the target pixel (DP), are illustrated (i.e., first-group corner patterns to be described later). In addition, examples of corner patterns, each of which includes one corner, are illustrated as denoted by PT_E to PT_H. In each of PT_E to PT_H of FIG. 4, various corner patterns each including a target pixel (DP) are illustrated (i.e., second-group corner patterns to be described later) such that the corner patterns share one vertex of the target pixel (DP) in the target kernel as a vertex of the corner. The corner patterns, shown in FIG. 4, are disclosed only for illustrative purposes, and there may exist various corner patterns, each of which is filled with a texture region and a non-texture region that are distinguished from each other based on the horizontal and vertical lines that serve as a boundary while crossing the kernel. That is, the size and shape of the texture region may vary. Thus, the location and number of corner patterns may also vary.

Although the embodiment of the disclosed technology assumes that there are eight corner patterns in the (5×5) kernel, this is merely for convenience of description, and other implementations are also possible. It should be noted that more diverse corner patterns may exist in a kernel that is larger than the (5×5) kernel as needed. The defective pixel correction method based on some implementations of the disclosed technology can also be applied in substantially the same way to these corner patterns.

However, gradation may occur in a boundary region in which a texture region and a non-texture region of the corner pattern coexist. Here, the boundary region may refer to a synthetic region in which pixel values of the texture region of the corner pattern and pixel values of the non-texture region of the corner pattern are not clearly distinguished from each other and the texture region and the non-texture region are not clearly distinguished from each other.

According to unique characteristics of the corner pattern, a difference in pixel value between pixels arranged in the diagonal direction may be smaller than a difference in pixel value between pixels arranged in the vertical direction or the horizontal direction. Accordingly, when determining a gradation directionality within the kernel in the boundary region of the corner pattern, the gradation directionality may be determined to be a diagonal direction. Therefore, when the directionality of the target kernel is unclear and ambiguous in the boundary region of the corner pattern, the target pixel (DP) cannot be accurately corrected.

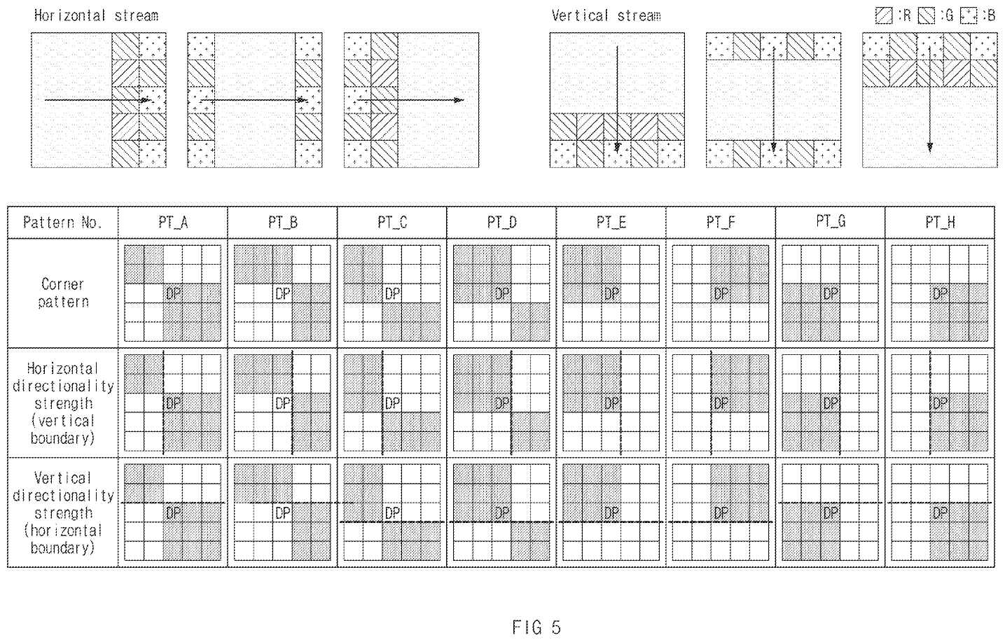

Accordingly, in order to prevent the target pixel (DP) from being wrongly corrected in the target kernel, it is necessary to accurately determine whether the target pixel (DP) is located in the boundary region of the corner pattern. The method for determining the boundary region of the corner pattern according to the embodiment of the disclosed technology will be described in more detail with reference to FIG. 5 to be described later.

FIG. 5 is a schematic diagram illustrating an example operation of determining the boundary of the corner pattern by the defective pixel corrector of FIG. 2 based on some implementations of the disclosed technology.

Referring to FIG. 5, the corner pattern determiner 210 may determine whether the target kernel including the target pixel (DP) corresponds to a corner pattern. That is, when a gradient exists in specific directions (for example, in the horizontal direction or in the vertical direction) within the kernel, pixel values may vary in a specific shape in which the pixel values increase or decrease in the corresponding direction having the gradient. Here, the increasing or decreasing shape of the pixel values might not be a linear shape.

In some implementations, the shape in which the directionality strength increases or decreases in a specific direction within the kernel may be referred to as a stream of pixel values (hereinafter referred to as a “pixel value stream”). For example, a shape in which pixel values increase (or decrease) in the horizontal direction may be referred to as a horizontal stream, and a shape in which pixel values increase (or decrease) in the vertical direction may be referred to as a vertical stream.

Corner patterns can be distinguished from each other based on a boundary indicating the horizontal and vertical lines crossing the kernel. When the corner patterns are distinguished in the horizontal and vertical directions, a boundary may exist in the vertical direction and a boundary may also exist in the horizontal direction.

When determining the directionality strength in the horizontal direction within the target kernel including the target pixel (DP), the pattern can be divided along the vertical boundary. On the other hand, when determining the directionality strength in the vertical direction within the target kernel including the target pixel (DP), the pattern can be divided along the horizontal boundary.

For example, the corner patterns (PT_A˜PT_H), shown in FIG. 4, may be used as reference. When the directionality strength is calculated in the horizontal direction of the target kernel, the corner pattern may be divided into left and right regions according to a vertical boundary vertically crossing the kernel. When the directionality strength is calculated in the vertical direction of the target kernel, the corner pattern may be divided into upper and lower regions according to a horizontal boundary horizontally crossing the kernel.

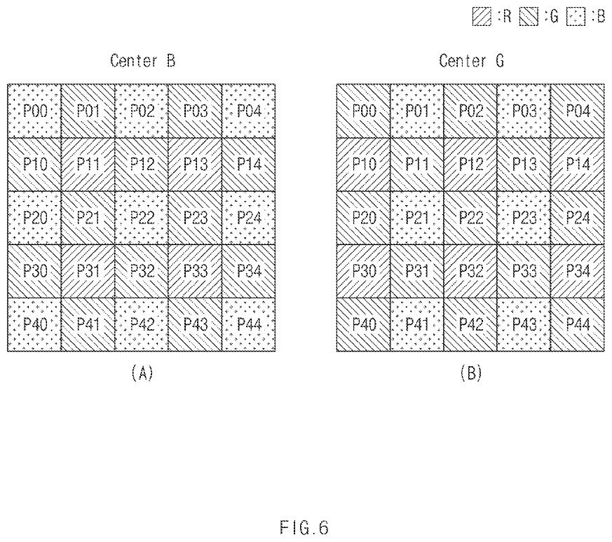

FIG. 6 is a schematic diagram illustrating an example of a target kernel arranged in a Bayer pattern based on some implementations of the disclosed technology.

FIGS. 6(A) and 6(B) are diagrams illustrating examples of (5×5)-sized target kernels arranged in a Bayer pattern. FIG. 6(A) may represent a Bayer pattern when the target pixel (DP) arranged at the center of the kernel is a blue pixel (B). FIG. 6(B) may represent a Bayer pattern when the target pixel (DP) arranged at the center of the kernel is the green pixel (G).

This target kernel may include the first to twenty-fifth pixels (P00, P01, P02, P03, P04, P10, P11, P12, P13, P14, P20, P21, P22, P23, P24, P30, P31, P32, P33, P34, P40, P41, P42, P43, P44) sequentially arranged in the direction from the upper-left side to the lower-right side.

FIG. 7 is a schematic diagram illustrating an example of a method for calculating the gradient sum by the first determiner 211 shown in FIG. 2 based on some implementations of the disclosed technology.

Referring to FIG. 7, the first determiner 211 may calculate the gradient sum for each specific direction within the target kernel. That is, the first determiner 211 may calculate the sum of difference values between pixel data values of two pixels paired for each of the combinations of pixels included in the target kernel and thus may calculate a gradient sum based on the calculated sum of the difference values. The pixel pair used in the process of calculating the gradient sum may refer to a pixel pair in which pixels of the same color (i.e., homogeneous pixels) are paired with each other. For each pattern, the pixel combination to be used to calculate the gradient sum corresponding to each pattern can be set in advance.

The first determiner 211 may determine the absence of a boundary region, such as a corner pattern, because a difference in pixel value between pixel pairs decreases as the calculated gradient sum decreases. On the other hand, the first determiner 211 may determine the presence of a boundary region in which the difference between pixel values changes abruptly in the same manner as in the corner pattern because a difference in pixel value between pixel pairs increases as the calculated gradient sum increases. That is, the first determiner 211 may determine that the position at which the largest gradient sum for each of the specific directions can be obtained is considered to be a position at which the corner pattern is located and may determine this position to be a boundary position of the corresponding direction.

Patterns (A) to (C) of FIG. 7 are schematic diagrams illustrating examples of a method for calculating the directionality strength of the horizontal direction using the pattern (A) of FIG. 6 as an example. The following equations 1 to 4 may represent examples of a method for calculating the directionality strength by calculating a gradient sum in the horizontal direction.

$$dh\_stream 1 = abs ( P 00 - P 02 ) + abs ( P 10 - P 12 ) + abs ( P 20 - P 22 ) + abs ( P 30 - P 32 ) + abs ( P 40 - P 42 ) \qquad [ Equation 1 ]$$

In Equation 1, ‘dh_stream1’ may denote the gradient sum of the horizontal direction (hereinafter referred to as a horizontal gradient sum) in the pattern (A) of FIG. 7, and ‘abs’ may denote an absolute value. For example, the horizontal gradient sum (dh_stream1) of the pattern (A) of FIG. 7 may be calculated by summing a difference value (abs (P00-P02)) between pixel data of the first pixel (P00) and pixel data of the third pixel (P02), a difference value (abs (P10-P12)) between pixel data of the sixth pixel (P10) and pixel data of the eighth pixel (P12), a difference value (abs (P20-P22)) between pixel data of the eleventh pixel (P20) and pixel data of the thirteenth pixel (P22), a difference value (abs (P30-P32)) between pixel data of the sixteenth pixel (P30) and pixel data of the eighteenth pixel (P32), and a difference value (abs (P40-P42)) between pixel data of the 21^{st} pixel (P40) and pixel data of the 23^{rd} pixel (P42).

$$dh\_stream 2 = abs ( P 01 - P 03 ) + abs ( P 11 - P 13 ) + abs ( P 21 - P 23 ) + abs ( P 31 - P 33 ) + abs ( P 41 - P 43 ) \qquad [ Equation 2 ]$$

In Equation 2, ‘dh_stream2’ may denote the gradient sum of the horizontal direction (hereinafter referred to as a horizontal gradient sum) in the pattern (B) of FIG. 7, and ‘abs’ may denote an absolute value. For example, the horizontal gradient sum (dh_stream2) of the pattern (B) of FIG. 7 may be calculated by summing a difference value (abs (P01-P03)) between pixel data of the second pixel (P01) and pixel data of the fourth pixel (P03), a difference value (abs (P11-P13)) between pixel data of the seventh pixel (P11) and pixel data of the ninth pixel (P13), a difference value (abs (P21-P23)) between pixel data of the twelfth pixel (P21) and pixel data of the fourteenth pixel (P23), a difference value (abs (P31-P33)) between pixel data of the seventeenth pixel (P31) and pixel data of the 19^{th} pixel (P33), and a difference value (abs (P41-P43)) between pixel data of the 22^{nd} pixel (P41) and pixel data of the 24^{th} pixel (P43).

$$[ Equation 3 ]$$

$$dh\_stream 3 = abs ( P 02 - P 04 ) + abs ( P 12 - P 14 ) + abs ( P 22 - P 24 ) + abs ( P 32 - P 34 ) + abs ( P 42 - P 44 )$$

In Equation 3, ‘dh_stream3’ may denote the gradient sum of the horizontal direction (hereinafter referred to as a horizontal gradient sum) in the pattern (C) of FIG. 7, and ‘abs’ may denote an absolute value. For example, the horizontal gradient sum (dh_stream3) of the pattern (C) of FIG. 7 may be calculated by summing a difference value (abs (P02-P04)) between pixel data of the third pixel (P02) and pixel data of the fifth pixel (P04), a difference value (abs (P12-P14)) between pixel data of the eighth pixel (P12) and pixel data of the tenth pixel (P14), a difference value (abs (P22-P24)) between pixel data of the thirteenth pixel (P22) and pixel data of the fifteenth pixel (P24), a difference value (abs (P32-P34)) between pixel data of the eighteenth pixel (P32) and pixel data of the twentieth pixel (P34), and a difference value (abs (P42-P44)) between pixel data of the 23^{rd} pixel (P42) and pixel data of the 25^{th} pixel (P44).

As described above, the first determiner 211 may calculate a difference in pixel data between pixel pairs located in a specific (5×3) region (or a (3×5) region) within the (5×5)-sized target kernel and thus may calculate gradient sums (dh_stream1, dh_stream2, dh_stream3) based on the calculated differences.

$$[ Equation 4 ]$$

$$max\_dh \_stream = MAX ( dh\_stream 1 , dh\_stream 2 , dh\_stream 3 )$$

In Equation 4, ‘max_dh_stream’ may denote a maximum gradient sum (i.e., the largest gradient sum) in the horizontal direction from among the gradient sums (dh_stream1, dh_stream2, dh_stream3). The position at which the maximum gradient sum from among the horizontal gradient sums can be obtained may indicate a boundary position in which the corner pattern exists.

Patterns (D) to (F) of FIG. 7 are schematic diagrams illustrating examples of a method for calculating the directionality strength in the vertical direction using the pattern (A) of FIG. 6 as an example. The following equations 5 to 8 may represent examples of a method for calculating the directionality strength by calculating the gradient sum in the vertical direction.

$$[ Equation 5 ]$$

$$dv\_stream 1 = abs ( P 00 − P 20 ) + abs ( P 01 − P 21 ) + abs ( P 02 − P 22 ) + abs ( P 03 − P 23 ) + abs ( P 04 − P 24 )$$

In Equation 5, ‘dh_stream1’ may denote the gradient sum of the vertical direction (hereinafter referred to as a vertical gradient sum) in the pattern (D) of FIG. 7, and ‘abs’ may denote an absolute value. For example, the vertical gradient sum (dh_stream1) of the pattern (D) of FIG. 7 may be calculated by summing a difference value (abs (P00-P20)) between pixel data of the first pixel (P00) and pixel data of the eleventh pixel (P20), a difference value (abs (P01-P21)) between pixel data of the second pixel (P01) and pixel data of the twelfth pixel (P21), a difference value (abs (P02-P22)) between pixel data of the third pixel (P02) and pixel data of the thirteenth pixel (P22), a difference value (abs (P03-P23)) between pixel data of the fourth pixel (P03) and pixel data of the fourteenth pixel (P23), and a difference value (abs (P04-P24)) between pixel data of the fifth pixel (P04) and pixel data of the fifteenth pixel (P24).

$$[ Equation 6 ]$$

$$dv\_stream 2 = abs ( P 10 − P 30 ) + abs ( P 11 − P 31 ) + abs ( P 12 − P 32 ) + abs ( P 13 − P 33 ) + abs ( P 14 − P 34 )$$

In Equation 6, ‘dv_stream2’ may denote the gradient sum of the vertical direction (hereinafter referred to as a vertical gradient sum) in the pattern (E) of FIG. 7, and ‘abs’ may denote an absolute value. For example, the vertical gradient sum (dv_stream2) of the pattern (E) of FIG. 7 may be calculated by summing a difference value (abs (P10-P30)) between pixel data of the sixth pixel (P10) and pixel data of the sixteenth pixel (P30), a difference value (abs (P11-P31)) between pixel data of the seventh pixel (P11) and pixel data of the seventeenth pixel (P31), a difference value (abs (P12-P32)) between pixel data of the eighth pixel (P12) and pixel data of the eighteenth pixel (P32), a difference value (abs (P13-P33)) between pixel data of the ninth pixel (P13) and pixel data of the nineteenth pixel (P33), and a difference value (abs (P14-P34)) between pixel data of the tenth pixel (P14) and pixel data of the twentieth pixel (P34).

$$[ Equation 7 ]$$

$$dv\_stream 3 = abs ( P 20 − P 40 ) + abs ( P 21 − P 41 ) + abs ( P 22 − P 42 ) + abs ( P 23 − P 43 ) + abs ( P 24 − P 44 )$$

In Equation 7, ‘dv_stream3’ may denote the gradient sum of the vertical direction (hereinafter referred to as a vertical gradient sum) in the pattern (F) of FIG. 7, and ‘abs’ may denote an absolute value. For example, the vertical gradient sum (dv_stream3) of the pattern (F) of FIG. 7 may be calculated by summing a difference value (abs (P20-P40)) between pixel data of the eleventh pixel (P20) and pixel data of the 21^{st} pixel (P40), a difference value (abs (P21-P41)) between pixel data of the twelfth pixel (P21) and pixel data of the 22^{nd} pixel (P41), a difference value (abs (P22-P42)) between pixel data of the thirteenth pixel (P22) and pixel data of the 23^{rd} pixel (P42), a difference value (abs (P23-P43)) between pixel data of the fourteenth pixel (P23) and pixel data of the 24^{th} pixel (P43), and a difference value (abs (P24-P44)) between pixel data of the fifteenth pixel (P24) and pixel data of the 25^{th} pixel (P44).

As described above, the first determiner 211 may calculate a difference in pixel data between pixel pairs located in a specific (5×3) region (or a (3×5) region) within the (5×5)-sized target kernel and thus may calculate gradient sums (dv_stream1, dv_stream2, dv_stream3) based on the calculated difference.

$$[ Equation 8 ]$$

$$max\_dv \_stream = MAX ( dv\_stream 1 , dv\_stream 2 , dv\_stream 3 )$$

In Equation 8, ‘max_dv_stream’ may denote a maximum gradient sum (i.e., the largest gradient sum) in the vertical direction from among the gradient sums (dv_stream1, dv_stream2, dv_stream3). The position at which the maximum gradient sum from among the vertical gradient sums can be obtained may indicate a boundary position in which the corner pattern exists.

FIG. 8 is a schematic diagram illustrating an example of the position of a target pixel in a corner pattern based on some implementations of the disclosed technology.

Referring to FIG. 8, the horizontal line crossing the kernel in the horizontal direction can be assumed to be a horizontal boundary region (EA_H), and the vertical line crossing the kernel in the vertical direction can be assumed to be the vertical boundary region (EA_V). The corner pattern of the kernel can be divided into corner regions based on the boundary regions (EA_H, EA_V).

For example, a corner region CA1 may be located above the horizontal boundary region EA_H and may be located to the left of the vertical boundary region EA_V. A corner region CA2 may be located above the horizontal boundary region EA_H and may be located to the right of the vertical boundary region EA_V. A corner region CA3 may be located below the horizontal boundary region EA_H and may be located to the left of the vertical boundary region EA_V. A corner region CA4 may be located below the horizontal boundary region EA_H and may be located to the right of the vertical boundary region EA_V. Here, the shaded corner regions (CA1, CA4) may be texture regions, and the unshaded corner regions (CA2, CA4) may be non-texture regions.

The target pixel (DP) may be located in various regions within the kernel. For example, the target pixel DP may be located in the corner region CA1 as denoted by A. The target pixel DP may be located in the vertical boundary region EA_V between the corner region CA1 and the corner region CA2, as denoted by B. The target pixel DP may be located in the corner region CA2 as denoted by C. The target pixel DP may be located in the horizontal boundary region EA_H between the corner region CA1 and the corner region CA3 as denoted by D. The target pixel DP may be located in a region where the vertical boundary region EA_V and the horizontal boundary region EA_H cross each other as denoted by E. The target pixel DP may be located in the horizontal boundary region EA_H between the corner region CA2 and the corner region CA4 as denoted by F. The target pixel DP may be located in the corner region CA3 as denoted by G. The target pixel DP may be located in the vertical boundary region EA_V between the corner region CA3 and the corner region CA4 as denoted by H. The target pixel DP may be located in the corner region CA4 as denoted by I.

The values of the maximum gradient sums (max_dh_stream, max_dv_stream), described in FIG. 7, may vary depending on which one of corner patterns within the target kernel includes the target pixel (DP). The first determiner 211 may determine the position of the target pixel DP in response to the value of the maximum gradient sum in the horizontal direction (max_dh_stream) and the value of the maximum gradient in the vertical direction (max_dv_stream).

TABLE 1

| Sum of Maximum | Sum of Maximum | |
|---|---|---|
| Gradients in vertical | Gradients in horizontal | |
| direction | direction | Position of |
| (max_dh_stream) | (max_dv_stream) | Target Pixel (DP) |
| dh_stream1 | dv_stream1 | I |
| dh_stream1 | dv_stream2 | F |
| dh_stream1 | dv_stream3 | C |
| dh_stream2 | dv_stream1 | H |
| dh_stream2 | dv_stream2 | E |
| dh_stream2 | dv_stream3 | B |
| dh_stream3 | dv_stream1 | G |
| dh_stream3 | dv_stream2 | D |
| dh_stream3 | dv_stream3 | A |

As shown in Table 1 above, the first determiner 211 may determine that the target pixel (DP) is located in the region A when the horizontal gradient sum dh_stream3 and the vertical gradient sum dv_stream3 are determined to be the largest values. Accordingly, the first determiner 211 may determine that the corner pattern is PT_D or PT_E when the target pixel (DP) is located in the region A.

The first determiner 211 may determine that the target pixel (DP) is located in the region C when the horizontal gradient sum dh_stream1 and the vertical gradient sum dv_stream3 are determined to be the largest values. Accordingly, the first determiner 211 may determine that the corner pattern is PT_C or PT_F when the target pixel (DP) is located in the region C.

The first determiner 211 may determine that the target pixel (DP) is located in the region G when the horizontal gradient sum dh_stream3 and the vertical gradient sum dv_stream1 are determined to be the largest values. Accordingly, the first determiner 211 may determine that the corner pattern is PT_B or PT_G when the target pixel (DP) is located in the region G.

The first determiner 211 may determine that the target pixel (DP) is located in the region (I) when the horizontal gradient sum dh_stream1 and the vertical gradient sum dv_stream1 are determined to be the largest values. Accordingly, the first determiner 211 may determine that the corner pattern is PT_A or PT_H when the target pixel (DP) is located in the region (I).

The first determiner 211 may determine that the target pixel (DP) is located in the region B when the horizontal gradient sum dh_stream2 and the vertical gradient sum dv_stream3 are determined to be the largest values. Accordingly, the first determiner 211 may determine that the corner pattern is PT_C, PT_D or PT_E, PT_F when the target pixel DP is located in the region B.

The first determiner 211 may determine that the target pixel (DP) is located in the region D when the horizontal gradient sum dh_stream3 and the vertical gradient sum dv_stream2 are determined to be the largest values. Accordingly, the first determiner 211 may determine that the corner pattern is any one of PT_B, PT_D, PT_E and PT_G when the target pixel (DP) is located in the region D.

The first determiner 211 may determine that the target pixel (DP) is located in the region F when the horizontal gradient sum dh_stream1 and the vertical gradient sum dv_stream2 are determined to be the largest values. Accordingly, the first determiner 211 may determine that the corner pattern is any one of PT_A, PT_C, PT_F and PT_H when the target pixel (DP) is located in the region F.

The first determiner 211 may determine that the target pixel (DP) is located in the region H when the horizontal gradient sum dh_stream2 and the vertical gradient sum dv_stream1 are determined to be the largest values. Accordingly, the first determiner 211 may determine that the corner pattern is any one of PT_A, PT_B, PT_G and PT_H when the target pixel (DP) is located in the region H.

The first determiner 211 may determine that the target pixel (DP) is located in the region E when the horizontal gradient sum dh_stream2 and the vertical gradient sum dv_stream2 are determined to be the largest values.

When the target pixel (DP) is located in the region B, D, F, or H, it cannot be considered that the target pixel (DP) is located at a specific corner in the corner pattern. Therefore, the condition of the corner pattern can be additionally determined by the second determiner 212 and the third determiner 213. In particular, when the target pixel (DP) is located in the region E (that crosses the horizontal boundary region and the vertical boundary region), it cannot be considered that the target pixel (DP) is located at a specific corner in the corner pattern only based on the conditions of the first determination unit 211. Therefore, the condition of the corner pattern can be additionally determined by the second determination unit 212 and the third determination unit 213.

FIG. 9 is a schematic diagram illustrating an example of a method for determining whether the gradient directions cross each other by the second determiner 212 of FIG. 2 based on some implementations of the disclosed technology.

Referring to FIG. 9, the second determiner 212 may determine whether the gradient directions of pixel pairs located to face each other in the edge region of the kernel cross each other. The embodiment of the disclosed technology will disclose an example of determining the gradient direction of green pixel(s) from among pixels located in the edge region of the kernel.

Pattern (A) of FIG. 9 is a schematic diagram illustrating an example of a method for determining whether the gradient directions cross each other in the horizontal direction by using pattern (A) of FIG. 6 as an example. The following equation 9 can represent a method for determining whether the gradient directions cross each other in the horizontal direction.

$$[ Equation 9 ]$$

$$dh\_stream \_dir \_diff = ( ( P 01 < P 03 ) \neq ( P 41 < P 43 ) )$$

The second determiner 212 may determine whether the gradient direction (P01<P03) of the green pixel pair (P01, P03) located in the upper edge region from among the edge regions of the kernel is different from the gradient direction (P41<P43) of the green pixel pair (P41, P43) located in the lower edge region from among the edge regions of the kernel. In Equation 9, ‘dh_stream_dir_diff’ may represent an example case in which the gradient directions of two pixel pairs are different from each other in the horizontal direction and are arranged to cross each other in the horizontal direction. For example, when the gradient directions cross each other (or are staggered from each other), this means that the pixel pairs (P01, P03, P41, P43) are located in the horizontal boundary region and the gradient directions are turned over (flipped) in the left-to-right direction.

Pattern (B) of FIG. 9 is a schematic diagram illustrating an example of a method for determining whether the gradient directions cross each other in the vertical direction by using pattern (A) of FIG. 6 as an example. The following equation 10 may represent a method for determining whether the gradient directions cross each other in the vertical direction.

$$[ Equation 10 ]$$

$$dv\_stream \_dir \_diff = ( ( P 10 < P 30 ) \neq ( P 14 < P 34 ) )$$

The second determiner 212 may determine whether the gradient direction (P01<P30) of the green pixel pair (P10, P30) located in the left edge region from among the edge regions of the kernel is different from the gradient direction (P14<P34) of the green pixel pair (P14, P34) located in the right edge region from among the edge regions of the kernel. In Equation 10, ‘dv_stream_dir_diff’ may represent an example case in which the gradient directions of two pixel pairs are different from each other in the vertical direction and are arranged to cross each other in the horizontal direction. For example, when the gradient directions cross each other, this means that the pixel pairs (P10, P30, P14, P34) are located in the vertical boundary region and the gradient directions are turned over (flipped) in the vertical direction.

Accordingly, when the second determiner 212 determines that the gradient directions of two pixel pairs are different from each other, the second determiner 212 may determine that the corresponding corner pattern is any one of the corner patterns (PT_A˜PT_D), shown in FIGS. 4 and 5. Here, each of the corner patterns (PT_A˜PT_D) may be a pattern including two corners that come in contact with one vertex of the target pixel (DP). The corner patterns (PT_A˜PT_D) may be referred to as corner patterns of the first group (hereinafter referred to as the first-group corner patterns) as described in FIGS. 2 and 3.

FIG. 10 is a schematic diagram illustrating an example of a method for determining whether the gradient directions are identical to each other by the second determiner 212 of FIG. 2 based on some implementations of the disclosed technology.

FIG. 10 illustrates examples of a plurality of pixel pairs used to determine whether the gradient directions are equal to each other. The second determiner 212 may determine whether the gradient directions of the plurality of pixel pairs are equal to each other.

In some implementations, in the horizontal direction, the gradient directions of pixel pairs of the same color (i.e., homogeneous pixel pairs) arranged in the second and fourth columns except for the pixels arranged in the left and right edge regions of the kernel and the pixels arranged in the center column of the kernel can be compared with each other. In some implementations, in the vertical direction, the gradient directions of pixel pairs of the same color (i.e., homogeneous pixel pairs) arranged in the second and fourth rows except for the pixels arranged in the upper and lower edge regions of the kernel and the pixels arranged in the center row of the kernel can be compared with each other. In the embodiment of FIG. 10, it is assumed that pixels having the gradient directions to be compared with each other are a pair of green pixels (hereinafter referred to as a green pixel pair) and a pair of red pixels (hereinafter referred to as a red pixel pair) for convenience of description.

FIG. 10(A) is a schematic diagram illustrating an example of a method for determining whether the gradient directions are identical to each other in the horizontal direction by using the pattern (A) of FIG. 6 as an example. The following equation 11 may represent a method for determining whether the gradient directions are equal to each other in the horizontal direction.

$$[ Equation 11 ]$$

$$dh\_stream \_dir \_same = ( ( P 01 < P 03 ) == ( P 11 < P 13 == ( P 21 < P 23 ) == ( P 31 < P 33 ) == ( P 41 < P 43 ) )$$

The second determiner 212 may determine whether the gradient direction (P01<P03) of the green pixel pair (P01, P03), the gradient direction (P11<P13) of the red pixel pair (P11, P13), the gradient direction (P21<P23) of the green pixel pair (P21, P23), the gradient direction (P31<P33) of the red pixel pair (P31, P33), and the gradient direction (P41<P43) of the green pixel pair (P41, P43) are equal to each other. In Equation 11, ‘dh_stream_dir_same’ may represent an example case in which the gradient directions of the plurality of pixel pairs are equal to each other in the horizontal direction. For example, pixel pairs (P01, P03, P11, P13, P21, P23, P31, P33, P41, P43) are not located in the horizontal boundary region, and the gradient directions thereof are the same in the horizontal direction.

FIG. 10(B) is a schematic diagram illustrating an example of a method for determining whether the gradient directions are identical to each other in the vertical direction by using the pattern (A) of FIG. 6 as an example. The following equation 12 may represent a method for determining whether the gradient directions are equal to each other in the vertical direction.

$$[ Equation 12 ]$$

$$dv\_stream \_dir \_same = ( ( P 10 < P 30 ) == ( P 11 < P 31 == ( P 12 < P 32 ) == ( P 13 < P 33 ) == ( P 14 < P 34 ) )$$

The second determiner 212 may determine whether the gradient direction (P10<P30) of the green pixel pair (P10, P30), the gradient direction (P11<P31) of the red pixel pair (P11, P31), the gradient direction (P12<P32) of the green pixel pair (P12, P32), the gradient direction (P13<P33) of the red pixel pair (P13, P33), and the gradient direction (P14<P34) of the green pixel pair (P14, P34) are equal to each other. In Equation 12, ‘dv_stream_dir_same’ may represent an example case in which the gradient directions of the plurality of pixel pairs are equal to each other in the vertical direction. For example, pixel pairs (P10, P30, P11, P31, P12, P32, P13, P33, P14, P34) are not located in the vertical boundary region, and the gradient directions thereof are the same in the vertical direction.

Accordingly, when the second determiner 212 determines that the gradient directions of the plurality of pixel pairs are equal to each other, the second determiner 212 may determine that the corresponding corner pattern is any one of the corner patterns (PT_E˜PT_H), shown in FIGS. 4 and 5. Here, the corner patterns (PT_E˜PT_H) may be patterns that share one vertex of the target pixel (DP) as a corner vertex. In each of the corner patterns (PT_E˜PT_H), the corner line forming the vertical boundary and the horizontal boundary may be in the shape of “ [symbol] ” or “ [symbol] ”. However, in the actual images, gradation may occur in the boundary region of the corner region so that the gradient directions can be determined to be the same. Accordingly, when the second determiner 212 determines that the gradient directions of the plurality of pixel pairs are equal to each other, the second determiner 212 may determine that the corresponding corner pattern is any one of the corner patterns (PT_E˜PT_H). The corner patterns (PT_E˜PT_H) may be referred to as corner patterns of the second group (hereinafter referred to as the second-group corner patterns) as described in FIGS. 2 and 3.

FIG. 11 is a schematic diagram illustrating an example of a method for determining whether the same gradient directions exist by the third determiner 213 of FIG. 2 based on some implementations of the disclosed technology.

Referring to FIG. 11, the third determiner 213 may determine whether patterns having the same gradient direction exist in the plurality of corner patterns by using the pattern (A) of FIG. 6 as an example. For example, the third determiner 213 may compare the gradient directions of the plurality of corner patterns (PT_A˜PT_H) with each other by using the corner patterns (PT_A˜PT_H) of FIGS. 4 and 5 as an example.

For example, for convenience of description, it is assumed that the gradient directions of the eight corner patterns PT_A to PT_H are denoted by corner_stream1 to corner_stream8, respectively. The gradient direction in the target kernel can be directed toward the lower-right end, the lower-left end, the upper-right end, or the upper-left end.

$$[ Equation 13 ]$$

$$corner\_stream 18 = ( ( P 03 < P 23 ) \& ( P 04 < P 24 ) \& ( P 13 < P 33 ) \& ( P 14 < P 34 ) \& ( P 30 < P 32 ) \& ( P 31 < P 33 ) \& ( P 40 < P 42 ) \& ( P 41 < P 43 ) \& ( P 02 < P 42 ) \& ( P 20 < P 24 ) \vert ( ! ( P 03 < P 23 ) \& ! ( P 04 < P 24 ) \& ! ( P 13 < P 33 ) \& ! ( P 14 < P 34 ) \& ! ( P 30 < P 32 ) \& ! ( P 31 < P 33 ) \& ! ( P 40 < P 42 ) \& ! ( P 41 < P 43 ) \& ! ( P 02 < P 42 ) \& ! ( P 20 < P 24 ) )$$

Equation 13 is an equation for determining whether the same gradient direction directed toward the lower-right end exists as denoted by corner patterns PT_A and PT_H. 10 gradient directions (corner_stream1) of the pixel pairs in the corner pattern (PT_A) and 10 gradient directions (corner_stream8) of the pixel pairs in the corner pattern (PT_H) may be identical to each other as represented by (P03<P23), (P04<P24), (P13<P33), (P14<P34), (P30<P32), (P31<P33), (P40<P42), (P41<P43), (P02<P42), and (P20<P24). That is, in ‘corner_stream18’, all of 10 gradient directions either satisfy the formula of “<” or do not satisfy the formula of “<” (here, the formula of “!” may indicate the case in which all of 10 gradient directions do not satisfy the formula of “<”) so that it can be determined that the gradient direction of ‘corner_stream1’ is identical to the gradient direction of ‘corner_stream8’.

$$[ Equation 14 ]$$

$$corner\_stream 27 = ( ( P 00 < P 20 ) \& ( P 01 < P 21 ) \& ( P 10 < P 30 ) \& ( P 11 < P 31 ) \& ( P 33 < P 31 ) \& ( P 34 < P 32 ) \& ( P 43 < P 41 ) \& ( P 44 < P 42 ) \& ( P 02 < P 42 ) \& ( P 24 < P 20 ) \vert ( ! ( P 00 < P 20 ) \& ! ( P 01 < P 21 ) \& ! ( P 10 < P 30 ) \& ! ( P 11 < P 31 ) \& ! ( P 33 < P 31 ) \& ! ( P 34 < P 32 ) \& ! ( P 43 < P 41 ) \& ! ( P 44 < P 42 ) \& ! ( P 02 < P 42 ) \& ! ( P 24 < P 20 ) ) \& ! ( P 33 < P 13 ) \& ! ( P 34 < P 14 ) \& ! ( P 43 < P 23 ) \& ! ( P 44 < P 24 ) \& ! ( P 20 < P 24 ) \& ! ( P 24 < P 20 ) )$$

Equation 14 is an equation for determining whether the same gradient direction directed toward the lower-left end exists as denoted by corner patterns PT_B and PT_G. 10 gradient directions (corner_stream2) of the pixel pairs in the corner pattern (PT_B) and 10 gradient directions (corner_stream7) of the pixel pairs in the corner pattern (PT_G) may be identical to each other as represented by (P00<P20), (P01<P21), (P10<P30), (P11<P31), (P33<P31), (P34<P32), (P43<P41), (P44<P42), (P02<P42), and (P24<P20). That is, in ‘corner_stream27’, all of 10 gradient directions either satisfy the formula of “<” or do not satisfy the formula of “<” (here, the formula of “!” may indicate the case in which all of 10 gradient directions do not satisfy the formula of “<”) so that it can be determined that the gradient direction of ‘corner_stream2’ is identical to the gradient direction of ‘corner_stream7’.

$$[ Equation 15 ]$$

$$corner\_stream 36 = ( ( P 00 < P 02 ) \& ( P 01 < P 03 ) \& ( P 10 < P 12 ) \& ( P 11 < P 13 ) \& ( P 33 < P 13 ) \& ( P 34 < P 14 ) \& ( P 43 < P 23 ) \& ( P 44 < P 24 ) \& ( P 20 < P 24 ) \& ( P 24 < P 20 ) \vert ( ! ( P 00 < P 02 ) \& ! ( P 01 < P 03 ) \& ! ( P 10 < P 12 ) \& ! ( P 11 < P 3 )$$

Equation 15 is an equation for determining whether the same gradient direction directed toward the upper-right end exists as denoted by corner patterns PT_C and PT_F. 10 gradient directions (corner_stream3) of the pixel pairs in the corner pattern (PT_C) and 10 gradient directions (corner_stream6) of the pixel pairs in the corner pattern (PT_F) may be identical to each other as represented by (P00<P02), (P01<P03), (P10<P12), (P11<P13), (P33<P13), (P34<P14), (P43<P23), (P44<P24), (P20<P24), and (P24<P20). That is, in ‘corner_stream36’, all of 10 gradient directions either satisfy the formula of “<” or do not satisfy the formula of “<” (here, the formula of “!” may indicate the case in which all of 10 gradient directions do not satisfy the formula of “<”) so that it can be determined that the gradient direction of ‘corner_stream3’ is identical to the gradient direction of ‘corner_stream6’.

$$[ Equation 16 ]$$

$$corner\_stream 45 = ( ( P 03 < P 01 ) \& ( P 04 < P 02 ) \& ( P 13 < P 11 ) \& ( P 14 < P 12 ) \& ( P 30 < P 12 ) \& ( P 31 < P 11 ) \& ( P 40 < P 20 ) \& ( P 41 < P 21 ) \& ( P 24 < P 20 ) \& ( P 42 < P 02 ) \vert ( ! ( P 03 < P 01 ) \& ! ( P 04 < P 02 ) \& ! ( P 13 < P 11 ) \& ! ( P 14 < P 12 ) \& ! ( P 30 < P 10 ) \& ! ( P 31 < P 11 ) \& ! ( P 40 < P 20 ) \& ! ( P 41 < P 21 ) \& ! ( P 24 < P 20 ) \& ! ( P 42 < P 02 ) )$$

Equation 16 is an equation for determining whether the same gradient direction directed toward the upper-left end exists as denoted by corner patterns PT_D and PT_E. 10 gradient directions (corner_stream4) of the pixel pairs in the corner pattern (PT_D) and 10 gradient directions (corner_stream5) of the pixel pairs in the corner pattern (PT_E) may be identical to each other as represented by (P03<P01), (P04<P02), (P13<P11), (P14<P12), (P30<P10), (P31<P11), (P40<P20), (P41<P21), (P24<P20), and (P42<P02). That is, in ‘corner_stream45’, all of 10 gradient directions either satisfy the formula of “<” or do not satisfy the formula of “<” (here, the formula of “!” may indicate the case in which all of 10 gradient directions do not satisfy the formula of “<”) so that it can be determined that the gradient direction of ‘corner_stream4’ is identical to the gradient direction of ‘corner_stream5’.

$$[ Equation 17 ]$$

$$only\_corner \_stream = ( ( corner\_stream 18 \& ! corner\_stream 27 \& ! corner\_stream 36 \& ! corner\_stream 45 ) \vert ( ! corner\_stream 18 \& \\ ! corner\_stream 27 \& ! corner\_stream 36 \& ! corner\_stream 45 ) \vert ( ! corner\_stream 18 \& ! corner\_stream 27 \& \\ ! corner\_stream 36 \& ! corner\_stream 45 ) \vert ( ! corner\_stream 18 \& ! corner\_stream 27 \& \\ ! corner\_stream 36 \& ! corner\_stream 45 ) )$$

In Equation 17, although the third determiner 213 determines two corner patterns by comparing the gradient directions with each other, the third determiner 213 may determine any one of two corner patterns based on the determination result of the second determiner 212 to be a target corner pattern.

Based on the values of ‘corner_stream18’, the third determiner 213 may determine that there is a pattern having the same gradient direction directed toward the lower-right end as denoted by the corner pattern (PT_A) and the corner pattern (PT_H).

That is, the third determiner 213 may determine that any one of the corner pattern (PT_A) and the corner pattern (PT_H) is the target corner pattern of the target kernel. If it is determined that the corner pattern determined by the second determiner 212 corresponds to the corner pattern of the first group, the third determiner 213 may finally determine that the corner pattern (PT_A) is the target corner pattern. On the other hand, when it is determined that the corner pattern determined by the second determiner 212 corresponds to the corner pattern of the second group, the third determiner 213 may finally determine the corner pattern (PT_H) to be the target corner pattern.

Based on the values of ‘corner_stream27’, the third determiner 213 may determine that there is a pattern having the same gradient direction directed toward the lower-left end as denoted by the corner pattern (PT_B) and the corner pattern (PT_G).

That is, the third determiner 213 may determine that any one of the corner pattern (PT_B) and the corner pattern (PT_G) is the target corner pattern of the target kernel. If it is determined that the corner pattern determined by the second determiner 212 corresponds to the corner pattern of the first group, the third determiner 213 may finally determine that the corner pattern (PT_B) is the target corner pattern. On the other hand, when it is determined that the corner pattern determined by the second determiner 212 corresponds to the corner pattern of the second group, the third determiner 213 may finally determine the corner pattern (PT_G) to be the target corner pattern.

Based on the values of ‘corner_stream36’, the third determiner 213 may determine that there is a pattern having the same gradient direction directed toward the upper-right end as denoted by the corner pattern (PT_C) and the corner pattern (PT_F).

That is, the third determiner 213 may determine that any one of the corner pattern (PT_C) and the corner pattern (PT_F) is the target corner pattern of the target kernel. If it is determined that the corner pattern determined by the second determiner 212 corresponds to the corner pattern of the first group, the third determiner 213 may finally determine the corner pattern (PT_B) to be the target corner pattern. On the other hand, when it is determined that the corner pattern determined by the second determiner 212 corresponds to the corner pattern of the second group, the third determiner 213 may finally determine the corner pattern (PT_F) to be the target corner pattern.

Based on the values of ‘corner_stream45’, the third determiner 213 may determine that there is a pattern having the same gradient direction directed toward the upper-left end as denoted by the corner pattern (PT_D) and the corner pattern (PT_E).

That is, the third determiner 213 may determine that any one of the corner pattern (PT_D) and the corner pattern (PT_E) is the target corner pattern of the target kernel. If it is determined that the corner pattern determined by the second determiner 212 corresponds to the corner pattern of the first group, the third determiner 213 may finally determine the corner pattern (PT_D) to be the target corner pattern. On the other hand, when it is determined that the corner pattern determined by the second determiner 212 corresponds to the corner pattern of the second group, the third determiner 213 may finally determine the corner pattern (PT_E) to be the target corner pattern.

FIGS. 12 to 15 are schematic diagrams illustrating examples of a method for compensating for the corner pattern by the pixel interpolator 220 shown in FIG. 2 based on some implementations of the disclosed technology.

Referring to FIGS. 12 to 15, when the corner pattern is determined by the first determiner 211, the second determiner 212, and the third determiner 213, the pixel interpolator 220 may determine an average (i.e., a weighted average) of weights of pixel data of peripheral pixels determined based on the corresponding target corner pattern, thereby interpolating the target pixel (DP) based on the weighted average.

According to one embodiment of the disclosed technology, the pixel interpolator 220 may apply a different weighted average to each pixel to be used for interpolation based on the position of the target pixel (DP) determined by the first determiner 211, thereby interpolating the target pixel (DP). The position of the target pixel (DP), shown in FIGS. 12 to 15, will be described using the example of FIG. 8 as an example. The pixel interpolator 220 may interpolate the target pixel (DP) by applying different weighted averages to the respective pixels based on whether the gradient directions determined by the second determiner 212 cross each other. The pixel interpolator 220 may interpolate the target pixel (DP) by applying different weighted averages to the respective pixels based on whether the corner pattern determined by the third determiner 213 has a gray level (gradation). That is, the pixel interpolator 220 may assign different weights to the respective pixels based on the determination conditions of the first determiner 211, the second determiner 212, and the third determiner 213, thereby interpolating the target pixel (DP).

According to another embodiment of the disclosed technology, the pixel interpolator 220 may compensate for the target pixel (DP) according to the color of the target pixel (DP). The pixel interpolator 220 may interpolate the target pixel (DP) by using peripheral homogeneous pixels having the same color as the target pixel (DP).

FIG. 12 is a schematic diagram illustrating an example of a compensation method by the pixel interpolator 220 when the target pixel (DP) located at the center of the kernel is a blue or red pixel and corresponds to a corner pattern with gradation. The embodiment of FIG. 12 will be described by taking an example case in which the target pixel (DP) is a blue pixel as shown in (A) of FIG. 8.

The pixel interpolator 220 may interpolate the target pixel (DP) based on a value obtained by applying a weight to pixel data of pixels (i.e., homogeneous pixels) having the same color as the target pixel (DP). For example, when the position of the target pixel (DP) corresponds to the region (I), the target corner pattern may be determined to be any one of PT_A and PT_H. When the second determiner 212 determines that the gradient directions cross each other, the second determiner 212 may determine the target corner pattern to be the corner pattern (PT_A). When the second determiner 212 determines that the gradient directions are equal to each other, the second determiner 212 may determine the target corner pattern to be the corner pattern (PT_H).

The pixels corresponding to the same color (e.g., blue color) as the target pixel (DP) may be the first pixel (P00), the third pixel (P02), the eleventh pixel (P20), the fifteenth pixel (P24), and the 23^{rd} pixel (P42), and the 25^{th} pixel (P44).

Accordingly, when the target corner pattern is the corner pattern (PT_A), the pixel interpolator 220 may use a weighted average of the first pixel (P00), the fifteenth pixel (P24), the 23^{rd} pixel (P42), and the 25^{th} pixel (P44) included in the texture region, and the third pixel (P02) and the eleventh pixel (P20) included in the non-texture region. For example, a weighted average of a first value obtained when ‘5’ is multiplied by pixel data of each of the fifteenth pixel (P24) and the 23^{rd} pixel (P42) that are located, a second value obtained when ‘2’ is multiplied by pixel data of each of the first pixel (P00) and the 25^{th} pixel (P44) that are located far from the target pixel (DP), and a third value obtained when ‘1’ is multiplied by pixel data of each of the third pixel (P02) and the eleventh pixel (P20) of the non-texture region located may be determined to be pixel data of the target pixel (DP).

When the target corner pattern is the corner pattern (PT_H), the pixel interpolator 220 may use a weighted average of the fifteenth pixel (P24), the 23^{rd} pixel (P42), and the 25^{th} pixel (P44) included in the texture region, and the third pixel (P02) and the eleventh pixel (P20) included in the non-texture region. For example, a weighted average of a first value obtained when ‘5’ is multiplied by pixel data of each of the fifteenth pixel (P24) and the 23^{rd} pixel (P42) that are located, a second value obtained when ‘2’ is multiplied by pixel data of the 25^{th} pixel (P44) located far from the target pixel (DP), and a third value obtained when ‘1’ is multiplied by pixel data of each of the third pixel (P02) and the eleventh pixel (P20) of the non-texture region located may be determined to be pixel data of the target pixel (DP).

Since the method of applying the weighted average differently based on the position of the target pixel (DP) is illustrated in FIG. 12, description of a method of applying the weighted average at the positions of the regions F to A will herein be omitted for brevity's sake.

In addition, when the position of the target pixel (DP) corresponds to the region (F), the target corner pattern may be determined to be any one of PT_A, PT_C, PT_F, and PT_H. When the second determiner 212 determines that the gradient directions cross each other, the second determiner 212 may determine the target corner pattern to be any one of PT_A and PT_C. When the second determiner 212 determines that the gradient directions are equal to each other, the second determiner 212 may determine the target corner pattern to be any one of PT_F and PT_H.

When the position of the target pixel (DP) corresponds to the region (C), the target corner pattern may be determined to be any one of PT_C and PT_F. When the second determiner 212 determines that the gradient directions cross each other, the second determiner 212 may determine the target corner pattern to be the corner pattern (PT_C). When the second determiner 212 determines that the gradient directions are equal to each other, the second determiner 212 may determine the target corner pattern to be the corner pattern (PT_F).

When the position of the target pixel (DP) corresponds to the region (H), the target corner pattern may be determined to be any one of PT_A, PT_B, PT_G, and PT_H. When the second determiner 212 determines that the gradient directions cross each other, the second determiner 212 may determine the target corner pattern to be any one of PT_A and PT_B. When the second determiner 212 determines that the gradient directions are equal to each other, the second determiner 212 may determine the target corner pattern to be any one of PT_G and PT_H.

When the position of the target pixel (DP) corresponds to the region (E), the target corner pattern may be determined to be any one of PT_A, PT_B, PT_C, PT_D, PT_E, PT_F, PT_G, and PT_H. When the second determiner 212 determines that the gradient directions cross each other, the second determiner 212 may determine the target corner pattern to be any one of PT_A, PT_B, PT_C, and PT_D. When the second determiner 212 determines that the gradient directions are equal to each other, the second determiner 212 may determine the target corner pattern to be any one of PT_E, PT_F, PT_G, and PT_H. The second determiner 212 may determine the corner pattern according to one side having a greater gradient sum (dh_stream) from among the left and right sides with respect to the horizontal direction and one side having a greater gradient sum (dv_stream) from among the top and bottom sides with respect to the vertical direction.

When the position of the target pixel (DP) corresponds to the region (B), the target corner pattern may be determined to be any one of PT_C, PT_D, PT_E, and PT_F. When the second determiner 212 determines that the gradient directions cross each other, the second determiner 212 may determine the target corner pattern to be any one of PT_C and PT_D. When the second determiner 212 determines that the gradient directions are equal to each other, the second determiner 212 may determine the target corner pattern to be any one of PT_E and PT_F.

When the position of the target pixel (DP) corresponds to the region (G), the target corner pattern may be determined to be any one of PT_B and PT_G. When the second determiner 212 determines that the gradient directions cross each other, the second determiner 212 may determine the target corner pattern to be the corner pattern (PT_B). When the second determiner 212 determines that the gradient directions are equal to each other, the second determiner 212 may determine the target corner pattern to be the corner pattern (PT_G).

When the position of the target pixel (DP) corresponds to the region (D), the target corner pattern may be determined to be any one of PT_B, PT_D, PT_E, and PT_G. When the second determiner 212 determines that the gradient directions cross each other, the second determiner 212 may determine the target corner pattern to be any one of PT_B and PT_D. When the second determiner 212 determines that the gradient directions are equal to each other, the second determiner 212 may determine the target corner pattern to be any one of PT_E and PT_G.

When the position of the target pixel (DP) corresponds to the region (A), the target corner pattern may be determined to be any one of PT_D and PT_E. When the second determiner 212 determines that the gradient directions cross each other, the second determiner 212 may determine the target corner pattern to be the corner pattern (PT_D). When the second determiner 212 determines that the gradient directions are equal to each other, the second determiner 212 may determine the target corner pattern to be the corner pattern (PT_E).

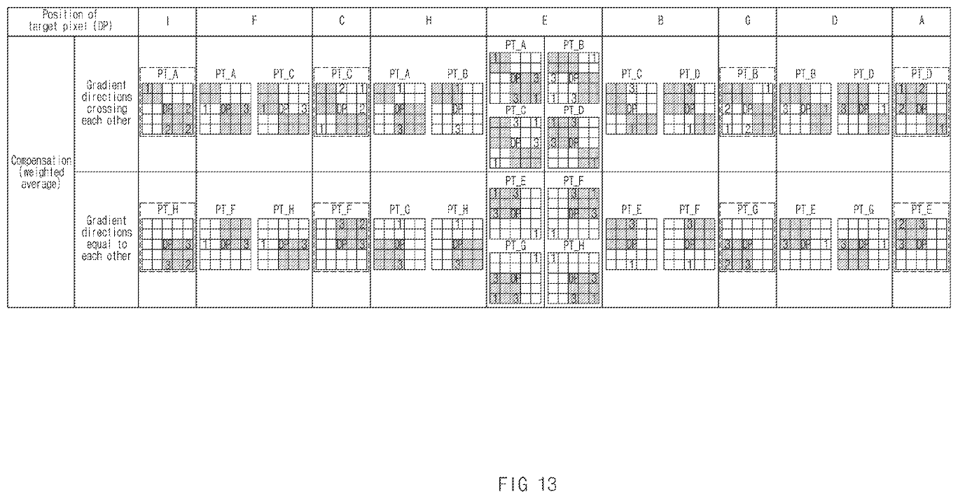

FIG. 13 is a schematic diagram illustrating an example of a compensation method by the pixel interpolator 220 when the target pixel (DP) located at the center of the kernel is a blue or red pixel and corresponds to a synthetic corner pattern without gradation. The embodiment of FIG. 13 will be described by taking an example case in which the target pixel (DP) is a blue pixel as shown in (A) of FIG. 6.

The pixel interpolator 220 may interpolate the target pixel (DP) based on a value obtained by applying a weight to pixel data of pixels (i.e., homogeneous pixels) having the same color as the target pixel (DP). For example, when the position of the target pixel (DP) corresponds to the region (I), the target corner pattern may be determined to be any one of PT_A and PT_H. When the second determiner 212 determines that the gradient directions cross each other, the second determiner 212 may determine the target corner pattern to be the corner pattern (PT_A). When the second determiner 212 determines that the gradient directions are equal to each other, the second determiner 212 may determine the target corner pattern to be the corner pattern (PT_H).

When the target corner pattern is the corner pattern (PT_A), the pixel interpolator 220 may use a weighted average of the first pixel (P00), the fifteenth pixel (P24), the 23^{rd} pixel (P42), and the 25^{th} pixel (P44) which have the same color (blue color) as the target pixel (DP). For example, a weighted average of a first value obtained when ‘2’ is multiplied by pixel data of each of the fifteenth pixel (P24) and the 23^{rd} pixel (P42) that are located, and a second value obtained when ‘1’ is multiplied by pixel data of each of the first pixel (P00) and the 25^{th} pixel (P44) that are located far from the target pixel (DP) may be determined to be pixel data of the target pixel (DP).

When the target corner pattern is the corner pattern (PT_H), the pixel interpolator 220 may use a weighted average of the fifteenth pixel (P24), the 23^{rd} pixel (P42), and the 25^{th} pixel (P44) which have the same color (blue color) as the target pixel (DP). For example, a weighted average of a first value obtained when ‘3’ is multiplied by pixel data of each of the fifteenth pixel (P24) and the 23^{rd} pixel (P42) that are located, and a second value obtained when ‘2’ is multiplied by pixel data of the 25^{th} pixel (P44) located far from the target pixel (DP) may be determined to be pixel data of the target pixel (DP).

Since the method of applying the weighted average differently based on the position of the target pixel (DP) is illustrated in FIG. 12, description of a method of applying the weighted average at the positions of the regions F to A will herein be omitted for brevity. In addition, the weights to be applied to each target kernel according to the embodiment of FIG. 13 may be the same as those of FIG. 12, and portions different from those of FIG. 12 are depicted separately (in the form of boxes), and as such redundant description thereof will herein be omitted for brevity's sake.

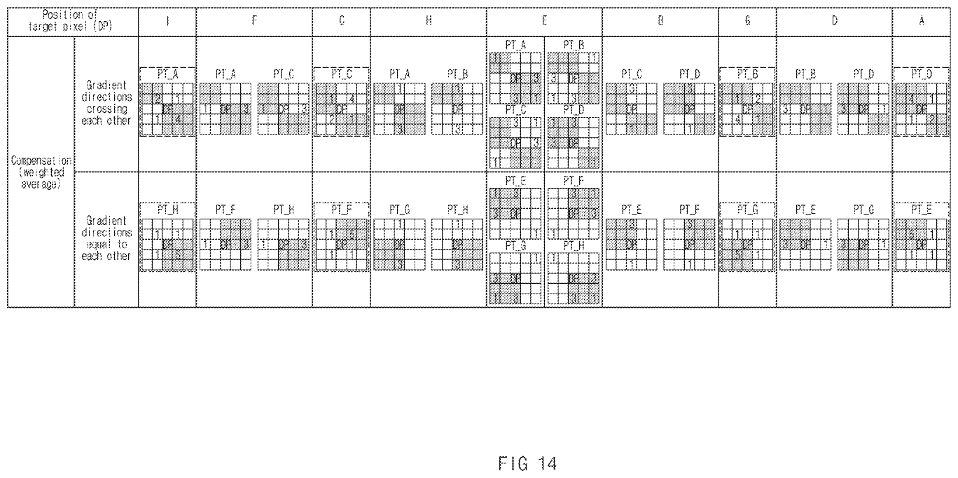

FIG. 14 is a schematic diagram illustrating an example of a compensation method by the pixel interpolator 220 when the target pixel (DP) located at the center of the kernel is a green pixel and corresponds to a corner pattern having gradation. The embodiment of FIG. 14 will be described by taking an example case in which the target pixel (DP) is a green pixel as shown in (A) of FIG. 6.

The pixel interpolator 220 may interpolate the target pixel (DP) based on a value obtained by applying a weight to pixel data of pixels (i.e., homogeneous pixels) having the same color as the target pixel (DP). For example, when the position of the target pixel (DP) corresponds to the region (I), the target corner pattern may be determined to be any one of PT_A and PT_H. When the second determiner 212 determines that the gradient directions cross each other, the second determiner 212 may determine the target corner pattern to be the corner pattern (PT_A). When the second determiner 212 determines that the gradient directions are equal to each other, the second determiner 212 may determine the target corner pattern to be the corner pattern (PT_H).

When the target corner pattern is the corner pattern (PT_A), the pixel interpolator 220 may use a weighted average of the seventh pixel (P11), the ninth pixel (P13), the seventeenth pixel (P31), and the nineteenth pixel (P33), which correspond to four homogeneous pixels (e.g., four green pixels) located closest to the target pixel (DP). For example, a weighted average of a first value obtained when ‘4’ is multiplied by pixel data of the nineteenth pixel (P33) located to the lower-right side of the target pixel (DP), a second value obtained when ‘1’ is multiplied by pixel data of each of the ninth pixel (P13) located to the upper-right side of the target pixel (DP) and the seventeenth pixel (P31) located to the lower-left side of the target pixel (DP), and a third value obtained when ‘2’ is multiplied by pixel data of the seventh pixel (P11) located to the upper-left side of the target pixel (DP) may be determined to be pixel data of the target pixel (DP).

When the target corner pattern is the corner pattern (PT_H), the pixel interpolator 220 may use a weighted average of the seventh pixel (P11), the ninth pixel (P13), the seventeenth pixel (P31), and the nineteenth pixel (P33) that have the same color (e.g., green color) as the target pixel (DP). For example, a weighted average of a first value obtained when ‘5’ is multiplied by pixel data of the nineteenth pixel (P33) located to the lower-right side of the target pixel (DP) a second value obtained when ‘1’ is multiplied by pixel data of each of the seventh pixel (P11) located to the upper-left side of the target pixel (DP), the ninth pixel (P13) located to the upper-right side of the target pixel (DP), and the seventeenth pixel (P31) located to the lower-left side of the target pixel (DP) may be determined to be pixel data of the target pixel (DP).

Since the method of applying the weighted average differently based on the position of the target pixel (DP) is illustrated in FIG. 14, description of a method of applying the weighted average at the positions of the regions F to A will herein be omitted for brevity. In addition, the weights to be applied to each target kernel according to the embodiment of FIG. 14 may be the same as those of FIG. 12, and portions different from those of FIG. 12 are depicted separately (in the form of boxes), and as such redundant description thereof will herein be omitted for brevity's sake.

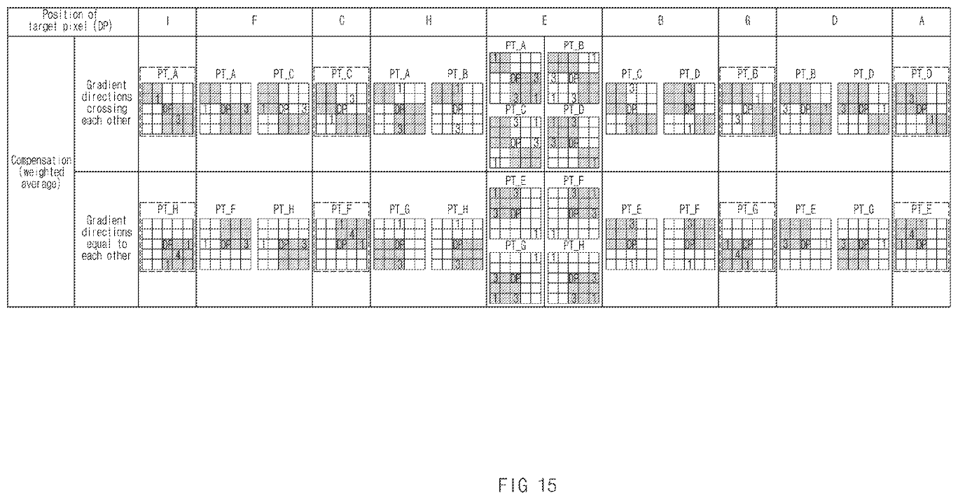

FIG. 15 is a schematic diagram illustrating an example of a compensation method by the pixel interpolator 220 when the target pixel (DP) located at the center of the kernel is a green pixel and corresponds to a corner pattern without gradation. The embodiment of FIG. 15 will be described by taking an example case in which the target pixel (DP) is a green pixel as shown in (B) of FIG. 6.

The pixel interpolator 220 may interpolate the target pixel (DP) based on a value obtained by applying a weight to pixel data of pixels (i.e., homogeneous pixels) having the same color as the target pixel (DP). For example, when the position of the target pixel (DP) corresponds to the region (I), the target corner pattern may be determined to be any one of PT_A and PT_H. When the second determiner 212 determines that the gradient directions cross each other, the second determiner 212 may determine the target corner pattern to be the corner pattern (PT_A). When the second determiner 212 determines that the gradient directions are equal to each other, the second determiner 212 may determine the target corner pattern to be the corner pattern (PT_H).

When the target corner pattern is the corner pattern (PT_A), the pixel interpolator 220 may use a weighted average of the seventh pixel (P11) and the nineteenth pixel (P33), which correspond to two homogeneous pixels (e.g., two green pixels) that are located closest to the target pixel (DP) and located diagonally to the target pixel (DP). For example, a weighted average of a first value obtained when ‘3’ is multiplied by pixel data of the nineteenth pixel (P33) located at the lower-right side from the target pixel (DP) and a second value obtained when ‘1’ is multiplied by pixel data of the seventh pixel (P11) located at the upper-left side from the target pixel (DP) may be determined to be pixel data of the target pixel (DP).

When the target corner pattern is the corner pattern (PT_H), the pixel interpolator 220 may use a weighted average of the nineteenth pixel (P33), corresponding to one homogeneous pixel (e.g., one green pixel) that is located closest to the target pixel (DP) within the texture region and located diagonally to the target pixel (DP), and the fifteenth pixel (P24) and the 23^{rd} pixel (P42) that are located below (P24) and to the right (P42) of the target pixel (DP) within the texture region. For example, a weighted average of a first value obtained when ‘4’ is multiplied by pixel data of the nineteenth pixel (P33), and a second value obtained when ‘1’ is multiplied by pixel data of each of the fifteenth pixel (P24) and the 23^{rd} pixel (P42) may be determined to be pixel data of the target pixel (DP).

Since the method of applying the weighted average differently based on the position of the target pixel (DP) is illustrated in FIG. 15, description of a method of applying the weighted average at the positions of the regions F to A will herein be omitted for brevity's sake. In addition, the weights to be applied to each target kernel according to the embodiment of FIG. 15 may be the same as those of FIG. 12, and portions different from those of FIG. 12 are depicted separately (in the form of boxes), and as such redundant description thereof will herein be omitted for brevity's sake.

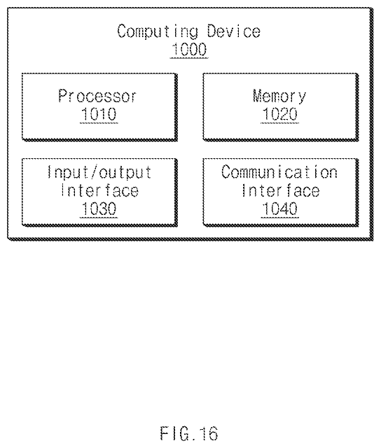

FIG. 16 is a block diagram showing an example of a computing device 1000 corresponding to the image signal processor of FIG. 1.

Referring to FIG. 16, the computing device 1000 may represent an embodiment of a hardware configuration for performing the operation of the image signal processor 100 of FIG. 1.

The computing device 1000 may be mounted on a chip that is independent of the chip on which the image sensing device is mounted. According to one embodiment, the chip on which the image sensing device is mounted and the chip on which the computing device 1000 is mounted may be implemented in one package, for example, a multi-chip package (MCP), but the scope of the disclosed technology is not limited thereto.

Additionally, the internal configuration or arrangement of the image sensing device and the image signal processor 100, described in FIG. 1, may vary depending on the embodiment. For example, at least a portion of the image sensing device may be included in the image signal processor 100. Alternatively, at least a portion of the computing device 1000 may be included in the image sensing device. In this case, at least a portion of the computing device 1000 may be mounted together on a chip on which the image sensing device is mounted.

The computing device 1000 may include a processor 1010, a memory 1020, an input/output interface 1030, and a communication interface 1040.

The processor 1010 may process data and/or instructions required to perform the operations of the components (150, 200) of the image signal processor 100 described in FIG. 1. That is, the processor 1010 may refer to the image signal processor 100, but the scope of the disclosed technology is not limited thereto.

The memory 1020 may store data and/or instructions required to perform operations of the components (150, 200) of the image signal processor 100, and may be accessed by the processor 1010. For example, the memory 1020 may be volatile memory (e.g., Dynamic Random Access Memory (DRAM), Static Random Access Memory (SRAM), etc.) or non-volatile memory (e.g., Programmable Read Only Memory (PROM), Erasable PROM (EPROM), etc.), EEPROM (Electrically Erasable PROM), flash memory, etc.).

That is, the computer program for performing the operations of the image signal processor 100 disclosed in this document may be recorded in the memory 1020 and executed and processed by the processor 1010, thereby implementing the operations of the image signal processor 100.

The input/output interface 1030 may be an interface that connects an external input device (e.g., keyboard, mouse, touch panel, etc.) and/or an external output device (e.g., display) to the processor 1010 to allow data to be transmitted and received.

The communication interface 1040 may be a component that can transmit and receive various data with an external device (e.g., an application processor, external memory, etc.) and may be a device that supports wired or wireless communication.

As is apparent from the above description, the image signal processor based on some implementations of the disclosed technology can increase the accuracy of correction of the target pixel even when the target kernel corresponds to a corner pattern.

The embodiments of the disclosed technology may provide a variety of effects capable of being directly or indirectly recognized through the above-mentioned patent document.

Although a number of illustrative embodiments have been described, it should be understood that modifications and enhancements to the disclosed embodiments and other embodiments can be devised based on what is described and/or illustrated in this patent document.

What is claimed is:

1. An image signal processor comprising:
a first determiner configured to determine whether a target kernel including a target pixel corresponds to a corner pattern;
a second determiner configured to determine a corner pattern group corresponding to the target kernel when the target kernel corresponds to the corner pattern;
a third determiner configured to determine a target corner pattern corresponding to the target kernel from among a plurality of corner patterns of a corner pattern group corresponding to the target kernel; and
a pixel interpolator configured to interpolate the target pixel using pixel data of a pixel corresponding to the target corner pattern.

2. The image signal processor according to claim 1,
wherein the corner pattern is a pattern filled with a texture region and a non-texture region,
wherein the texture region and the non-texture region are distinguished from each other through boundary lines, and
wherein the boundary lines include:
a horizontal line passing through the target kernel, contacting one side of the target pixel; and
a vertical line passing through the target kernel, contacting another side of the target pixel.

3. The image signal processor according to claim 1, wherein the first determiner is configured to:
calculate a gradient sum in a specific direction within the target kernel; and
determine whether the target kernel corresponds to the corner pattern based on the gradient sum.

4. The image signal processor according to claim 3, wherein the gradient sum is a sum of differences between pixel data values of pixel pairs arranged in each direction of the target kernel.

5. The image signal processor according to claim 3, wherein the first determiner is configured to:
determine that the target kernel does not correspond to the corner pattern when the gradient sum is less than a first value; and
determine that the target kernel corresponds to the corner patterns when the gradient sum is greater than the first value.

6. The image signal processor according to claim 3, wherein the first determiner is configured to:
determine a position at which the largest gradient sum for each direction of the target kernel is obtained to be a boundary position at which the target corner pattern exists.

7. The image signal processor according to claim 1, wherein the first determiner is configured to:
calculate a gradient sum in a specific direction within the target kernel; and
determine which region of the target corner pattern includes the target pixel based on the gradient sum.

8. The image signal processor according to claim 7, wherein the first determiner is configured to:
calculate a maximum gradient sum in a horizontal direction of a plurality of pixel pairs located in a specific region within the target kernel and a maximum gradient sum in a vertical direction of the plurality of pixel pairs located in the specific region within the target kernel; and
determine a position of the target pixel based on the maximum gradient sum in the horizontal direction and the maximum gradient sum in the vertical direction.

9. The image signal processor according to claim 1, wherein the second determiner is configured to:
determine whether gradient directions of pixel pairs located to face each other in an edge region of the target kernel cross each other and determine that the target corner pattern corresponds to a corner pattern of a first group when the gradient directions cross each other; and
determine whether the gradient directions of a plurality of pixel pairs arranged in a specific region within the target kernel are equal to each other and determine that the target corner pattern corresponds to a corner pattern of a second group when the gradient directions of the plurality of pixel pairs in the specific region within the target kernel are equal to each other.

10. The image signal processor according to claim 9, wherein the corner pattern of the first group includes two corners that come in contact with each other at one vertex of the target pixel.

11. The image signal processor according to claim 9, wherein the corner pattern of the second group is configured to share one vertex of the target pixel as a vertex of a corner.

12. The image signal processor according to claim 1, wherein the third determiner is configured to:
compare gradient directions of the plurality of corner patterns with each other; and
determine whether there is a pattern having the same gradient direction in a corner direction from among the plurality of corner patterns.

13. The image signal processor according to claim 12, wherein the third determiner is configured to:
determine whether the gradient directions are directed toward a lower-right end, a lower-left end, an upper-right end, or an upper-left end with respect to a vertical boundary and a horizontal boundary within the target kernel; and
determine two corner patterns having the same gradient direction.

14. The image signal processor according to claim 13, wherein the third determiner is configured to:
when the corner pattern group corresponding to the target kernel is a corner pattern of a first group, determine a corner pattern corresponding to the corner pattern of the first group from among the two corner patterns to be the target corner pattern; and
when the corner pattern group corresponding to the target kernel is a corner pattern of a second group, determine a corner pattern corresponding to the corner pattern of the second group from among the two corner patterns to be the target corner pattern.

15. The image signal processor according to claim 1, wherein the pixel interpolator is configured to:
interpolate the target pixel by applying a weighted average to the target corner pattern based on the determination results of the first determiner, the second determiner, and the third determiner.

16. An image signal processing method comprising:
distinguishing a plurality of corner patterns from each other, each having a different type, by using horizontal and vertical lines crossing a target kernel and forming a boundary for a target pixel included in the target kernel;
classifying the plurality of corner patterns into corner patterns of a first group and corner patterns of a second group;
determining a target corner pattern from among corner patterns corresponding to one of the first-group corner pattern and the second-group corner pattern; and
interpolating the target pixel using pixel data of a pixel corresponding to the target corner pattern.

17. The image signal processing method according to claim 16, wherein the classifying the plurality of corner patterns includes:
calculating a gradient sum in a specific direction within the target kernel;
determining whether the target kernel corresponds to the plurality of corner patterns based on the gradient sum; and
determining which region of a corresponding corner pattern includes the target pixel based on the gradient sum.

18. The image signal processing method according to claim 16, wherein the classifying the plurality of corner patterns includes:
determining corner patterns including two corners that come in contact with each other at one vertex of the target pixel to be the corner patterns of the first group; and
determining corner patterns that share one vertex of the target pixel as a vertex of a corner to be the corner patterns of the second group.

19. The image signal processing method according to claim 16, wherein the classifying the plurality of corner patterns includes:
determining whether gradient directions of pixel pairs located to face each other in an edge region of the target kernel cross each other and determining that the target corner pattern corresponds to a corner pattern of a first group when the gradient directions cross each other; and
determining whether the gradient directions of a plurality of pixel pairs arranged in a specific region within the target kernel are equal to each other and determining that the target corner pattern corresponds to a corner pattern of a second group when the gradient directions of the plurality of pixel pairs in the specific region within the target kernel are equal to each other.

20. The image signal processing method according to claim 16, wherein the determining the target corner pattern includes:
determining whether there are two corner patterns having the same gradient direction by comparing gradient directions of the plurality of corner patterns with each other;
when the corner pattern group corresponding to the target kernel is the corner pattern of the first group, determining a corner pattern corresponding to the corner pattern of the first group from among the two corner patterns to be the target corner pattern; and
when the corner pattern group corresponding to the target kernel is the corner pattern of the second group, determining a corner pattern corresponding to the corner pattern of the second group from among the two corner patterns to be the target corner pattern.
